(19) United States
(12) Patent Application Publication
(10) Pub. No.: US 2010/0042592 A1
(43) Pub. Date: Feb. 18, 2010

(54) SYSTEM AND METHODS FOR FACILITATING USER- REQUESTED CONTENT SERVICES AND RELATED TECHNOLOGIES

(76) Inventors: Pascal Stolz, Kirkland, WA (US); Juan Miguel Lavista Ferres, Kirkland, WA (US); William M. Fawthrop, Kirkland, WA (US); Andrés Nicolás Charbonier Etchenique, Montevideo (UY); Diego Acosta Mislej, Kirkland, WA (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 12/538,749

(22) Filed: Aug. 10, 2009

Related U.S. Application Data
(60) Provisional application No. 61/188,667, filed on Aug. 11, 2008.
(60) Provisional application No. 61/094,316, filed on Sep. 4, 2008.
(60) Provisional application No. 61/095,190, filed on Sep. 8, 2008.
(60) Provisional application No. 61/101,519, filed on Sep. 30, 2008.

(51) Int. Cl. G06F 17/30

(52) U.S. Cl. 707/3; 707/E17.014

(57) ABSTRACT

Aspects of the invention include a system and a method of providing a scalable system architecture and methods facilitating user-requested content alerts. Additionally, aspects of the invention are directed to a system and method of providing customized alerts to a user link atoms corresponding to discrete subjects of information requested by the user to form molecules which can be received by an interactive media device to display the information corresponding to each atom. Other aspects of the invention include a system and a method of facilitating user-requested content utilizing Real Simple Syndication (RSS). The present invention is further directed at providing a system and method for expanding user-requested content, and systems and methods of facilitating monetization of user-requested content via electronic mail.

### PRIOR APPLICATIONS

This Application claims the benefit of the following U.S. Provisional Applications, each of which is incorporated by reference herein in its entirety.

| Application | | |
|---|---|---|
| No. | Title | Filing Date |
| 61/188,667 | SYSTEMS AND METHODS | Aug. 11, 2008 |
| | FACILITATING MONETIZATION OF | |
| | USER-REQUESTED CONTENT | |
| | VIA ELECTRONIC MAIL | |
| 61/094,316 | SYSTEM AND METHOD | Sep. 4, 2008 |
| | FOR EXPANDING | |
| | USER-REQUESTED CONTENT | |
| 61/095,190 | SYSTEMS AND METHODS | Sep. 8, 2008 |
| | FACILITATING USER-REQUESTED | |
| | CONTENT UTILIZING | |
| | REAL SIMPLE SYNDICATION | |
| 61/101,519 | SCALABLE SYSTEM | Sep. 30, 2008 |
| | ARCHITECTURE AND METHODS | |
| | FACILITATING USER- | |
| | REQUESTED CONTENT ALERTS | |

### FIELD OF THE INVENTION

The present invention relates generally to information technology for defining, generating and providing content-specific alerts, reminders, or notifications (as a whole named Alerts) to a user utilizing at least one communications network in response to an initiated or uninitiated user request.

### BACKGROUND OF THE INVENTION

The Web has been continuously evolving as developers strive to provide better and more relevant information to users, or customers. Starting with static HTML pages, the Web quickly evolved to include dynamically generated sites and content. Consumers today rely to a large extent on search functionality for many of their daily information needs. The more information they need the more they search. In the last few years several technologies have been introduced in efforts to offer further improvements to consumer experiences for finding information. In some instances these technologies further refined the ability for consumers to search in pre-defined vertical categories of content. In other instances results from searches were categorized or filtered to better organize the results of each search across meta data elements. Other technologies, such as Real Simple Syndication (RSS) were aimed to provide information to users, pre sorted according to specific criteria defined by the publisher of the information.

The challenges that consumers often experience include the constant need to make repeated searches in order to identify relevant content or to sort through pre-aggregated content (e.g. RSS feeds) to identify the presence of any information pertinent and relevant to their needs. Thus, although Web searches have allowed users to receive query-specific content over the Web, searches are often unable to deliver to users the information they want, when they want it, and where they want it.

A relatively new approach to Internet-based content delivery that addresses some of the challenges outlined above involves content providers, or publishers, delivering information in response to pre-configured requests by users. In this approach, known generally as Alerts, a user, or customer, requests content by specifying a type or category of desired information, along with optionally specifying parameter settings to narrow down the information type to a subset particularly relevant to the customer. In this manner, the information provided to the customer is contextualized for a service associated with or requested by the customer. For example, a customer desiring flight information, such as fares to a destination during a range of dates and within a specified price range, can be notified when such flights are available. Since this information is of particular interest to the customer, the information is less likely to be ignored. Not only does this provide a useful service to the customer, but it can significantly increase the opportunities available to advertisers to precisely reach consumers.

A practical Alerts system amenable to being widely adopted by consumers of information would need to provide a large offering of content type from many disparate sources. Alerts providers to date have been offering a limited selection of alert types that corresponds to the extent of content that each Alerts provider is able to generate. Additionally, a practical Alerts system would need to handle very large volumes of alert requests, many of which are time-critical. This would place particular burdens on the systems that generate the content of each alert, and on the systems that deliver the alerts at the requested times. Furthermore, with a broad profile of potential users each with potentially specific requirements and a board spectrum of devices to which Alerts are to be delivered, a practical Alerts system would need to place power in the hands of users as to where and when their alerts are to be delivered. Specifically, a practical solution for an Alerts system is therefore needed that addresses these, and other, challenges.

The increased reliance by users upon “Search” to look for and attempt to find relevant information has caused Search to become one of the largest advertising businesses on the internet, almost displacing the more traditional display advertisements.

A drawback to Search, which happens at an atomic level, is that it fails to deliver specific or exact complementary results to that search query. This forces users to make repeated searches to identify related or complementary results. Though a nuisance for users, the repetitive nature of this type of searching increases the opportunities for advertisers to deliver even more ad impressions. For example, doing a search for an airfare between Seattle and San Francisco will return several airline choices but may not provide results for a rental car or a hotel. In other words, creating additional opportunities for Search creates additional opportunities for ads to be served.

Although Search has allowed users to receive query-specific content over the web, Search is often unable to deliver to users the information they want, when they want it, and where they want it. To this extent, improvements have been made that permit web content to deliver information in response to customer requests. In particular, an improvement of the current user experience would be to provide “alerts” in accordance with known user requests or preferences. In this manner, the information provided to the user is contextualized for a service associated with or requested by the user. For example, a user desiring flight information, such as fares to a destination during a range of dates and within a specified price range, could be notified when such flights are available. Since this information is of particular interest to the user, the information is less likely to be ignored. Not only would this provide a useful service to the user, but it increases the opportunities available to advertisers.

Similar to Search, the use of alerts would be based on an association of information at an atomic level and would allow for additional related or complementary information to be suggested. Search-based websites such as Expedia, Travelocity, Orbitz and other specialty travel sites have capitalized on this opportunity by offering, in addition to their tailored “vertical” search results, the opportunity to book complementary services. If a user request to “watch a fare,” however, on web content relating to airfare is monitored and delivered to the user, while web content relating to similar or complementary services is ignored. As a result, users would need to perform repeated searches in order to add the complementary elements of their desired “watch” experience.

Known solutions for delivering, to a user, information that is derived from associations of related or complementary content that has been correlated through user behavior generally require learning from a group of users over time in order to refine the offers given to particular users. For example, in systems that provide for a particular user who has purchased or inquired about a specific book to be identified and subsequently presented with an offer to purchase a different book which was purchased by users who exhibited the same pattern of purchase as the particular user. An inherent limitation of such systems is an inability to learn from a group of users without the benefit of an existing prior transaction history.

Current practices incorporating correlative recommendations are focused on the sale industry, such as through the cross-selling of products and services and encouraging e-commerce transactions, rather than the advertising industry. To date, a practical approach has not been proposed that would enable businesses delivering of targeted advertisements to increase the number of opportunities for users to subscribe to user-requested content and serve the additional targeted advertisements.

Another very promising technology has emerged, known as Real Simple Syndication (RSS). RSS is a document (often called a “feed,” “web feed,” or “channel”) which typically includes full or summarized text plus metadata such as publishing dates and authorship. A standardized XML file, residing on a Web server, allows the information to be published once and viewed by many different programs. Web feeds benefit publishers by letting them syndicate content quickly and automatically. They also benefit readers who want to subscribe to timely updates from favored websites or to aggregate feeds from many sites into one place.

RSS feeds are typically read using software called an “RSS reader,” “feed reader,” or an “aggregator,” which can be web-based or desktop-based. The user subscribes to a feed by entering the feed's link into the reader or by clicking an RSS icon in a browser that initiates the subscription process. The RSS reader checks the user's subscribed feeds regularly for new work and pulls the information every x number of minutes from the server, downloads any updates that it finds, and provides an interface to users to monitor and read the feeds. Users are thus required to go to their reader for any updates.

RSS was initially hailed as the holy grail for content access. However it has failed to deliver on expectations as most internet users still don't know what RSS is, and really don't care. Google Trends analysis, http://www.google.com/trends/viz?q=rss&date=all&geo=all&graph=weekly_img&sort=0&sa=N, shows how the hype around RSS worked in its favor initially to then slowly regress to the point that there are less people interested in RSS in 2008 than in 2004.

The challenge and nuisance consumers that cited are the constant need to still make repeated reviews to sort through the RSS pre-aggregated content in readers to identify if there is any information pertinent and relevant to their needs. Thus, although RSS has allowed users to receive query-specific content over the web, RSS is often unable to deliver to users the information they want, when they want it, and where they want it.

The challenge RSS is experiencing as a technology is quite similar to the challenge the web experienced with the vast proliferation of web pages and content. In early 2007, it was reported that 604,533 feeds were available on behalf of 347,000 bloggers, podcasters and commercial publishers. In many instances these feeds cover very similar topics making the selection of information and the usefulness of readers cumbersome for users. Since early 2007 the numbers of feeds has continued to grow while adoption has continued to decline. There is too much content to consume and every feed may or may not have the content a user is interested in.

To this extent, improvements are needed that permit publishers who expose their web content via RSS to offer consumers the opportunity to receive information in response to their requests. In particular, an improvement to the current user experience would be to provide “alerts” in accordance with known user requests or preferences. In this manner, the information provided to the user is contextualized for a service associated with or requested by the user. Since this information is of particular interest to the user, the information is less likely to be ignored.

An additional means of conveying information to users or customers is through email. Even though email has been the primary communication medium in our digital era and, as such, could have been effectively leveraged as an advertising delivery platform, email has yet to break through as a viable medium. There are billions of emails being sent every day and, unfortunately, a very significant number of those are unsolicited emails or spam. Spam is a form of email solicitation whereby someone intrudes in a user's inbox by making unsolicited offers for goods and/or services. That practice is generally regarded as one of the primary reasons that prevented email from becoming a powerful advertising medium. The industry thus focused on the web, with its structure of dynamically generated web pages, which paved the way for targeted advertisements. These advertisements took the form of display ads and text ads, contextually served as a function of the page on which the ads are to appear. This dynamic targeting of advertisements, which advertisers desire, also burdened email as a viable advertising platform as email systems and clients do not support the necessary technology to enable such targeting. Legitimate advertisers and publishers are consequently oriented against promoting email as an effective advertising medium.

The world of online advertising is primarily regulated along three main business models: cost per impression (CPM), cost per click (CPC) and cost per action (CPA). In addition, advertisers typically construct their advertising campaigns with specific goals in mind, either in terms of total impressions, total clicks or total actions. For example, an advertiser might consider offering 50% off a certain product for a certain duration to seed a product in the marketplace. After the advertiser's goals are reached the advertiser will elect to eliminate the offer, selling the products at full price. Similarly, an advertiser might set a goal of number of impressions or clicks to be purchased and once that campaign has been served the advertisement is being pulled.

This practice is often referred to as “capped” campaigns requiring advertising networks to precisely manage the distribution of the advertising inventory. Delivery of more than the capped campaigns isn't being compensated by advertisers and in many cases exceeding the delivery creates challenges in ad networks tracking systems. In essence the advertisements have to be dynamically served and ads on web pages cannot be cached.

Another interesting and unique capability of advertising networks is to target the advertisements as a function of the content on a page whereby the ad server performs a read on the page to extract the contextual elements of that page and serves ads most relevant as a function of that contextual content. In addition, the ad server can add geographic targeting capabilities by detecting the IP address of the user viewing the page and inferring the location of that user. These capabilities have proven extremely powerful in increasing the targeting accuracy of campaigns significantly impacting conversion rates as well.

The world of email is vastly different than that of web pages even though many emails are delivered using the HTML protocol. Because of spam and security reasons, many email client programs prevent images from being displayed until a user specifically requests these images to be downloaded. Some email clients only accept text email and no HTML email. Some users only accept text email as well. There is no predictive ability to understand when and if an email will be opened and if the images will be downloaded. There is little ability to also understand when any of these conditions might happen nor how often they might happen.

As a result, the common practice is to have images and or advertisement in email be cached for delivery when any one of those events occurs. Consequently, it is virtually impossible for ad networks to serve capped advertising campaigns into email since there is no ability to control how these ads are being served. For example, a user may elect to read an email upon receipt and store it for future reference. The initial view of the email could have involved wither downloading or not downloading images. Then, a few days later the user may elect to again review the email, this time downloading the images. If an image associated with the email happened to be an advertisement offering a 50% discount seeding program, for instance, and by the time the recipient views the email the seeding campaign had already been concluded, that advertiser or ad network may nevertheless need to honor the offer. Considering the possibility of millions of emails with the same advertisement and the financial risk and/or loss to the advertiser or ad network, email advertising using that caching technique is generally regarded as impractical. Unless used with very heavy Java scripting embedded in the email, there is no way for advertisers to understand when their ads might be served and the advertisement delivered, and there is no way for advertisers to protect themselves from making untimely offers when using email as an advertising network. The use of Java scripting presents security risks for users, and is also not a viable solution due to filtering by email clients.

Furthermore, the contextualization for serving targeted ads on emails is presently not enabled since an ad network lacks the capability of identifying the content of the email or the geo location of the user since context understanding and IP address detection can't be made on the fly.

As the industry shied away from email due to spam, capped campaigns, and issues with caching, no practical systems have been put in place to address the above-described concerns, and other related concerns, of ad campaigns delivered in email. The overall infrastructure for advertising delivery on digital mediums is largely based on the necessity for the dynamic nature of advertising delivery, thus further creating hurdles for enabling email as a viable advertising medium.

It has been demonstrated repeatedly that email is a very powerful medium for user acquisition and retention, often outperforming print and websites. Providing a solution to serve advertisements into emails would present a several billion-dollar ad network opportunity and could significantly change the advertising landscape.

### SUMMARY OF THE INVENTION

### Alerts

Aspects of the invention are directed to a computer-implemented system and method that gathers and delivers content that has been requested by customers in the form of alerts, notifications, reminders, and the like, collectively referred to herein as Alerts. In one aspect of the invention, an Alerts system includes an Alerts engine, a plurality of Alerts agents, and a plurality of distribution channels. The functionality of the Alerts engine includes maintaining customer accounts and facilitating the set-up of Alerts by the customer, coordinating information exchange with the Alerts agents and distribution channels, packaging of Alerts to be delivered, facilitating information exchange with advertisers, and scheduling delivery of Alerts, where appropriate, all across multiple content sources and delivery channels. The Alerts agents gather current content that is the subject of the individual Alerts being requested. Each of the distribution channels includes at least one information network utilized to deliver the Alerts to the customers such as, for example, email, short messaging (SMS), voice communications, instant messaging (IM), real simple syndication (RSS), and the like.

According to one aspect of the invention, each of the Alerts engine, the Alerts agents, and the distribution channels can be implemented as a separate computer system and at a separate location by virtue of the system having a distributable architecture. As such, the architecture of an Alerts system according to this aspect has the “what” (i.e. content), the “when” (i.e. schedule), the “where” (i.e. delivery channels) decoupled from one another. Numerous advantages are provided by virtue of the system architecture in which these functions are decoupled.

For example, the Alerts agents and the distribution channels can be operated by third parties that are distinct from the operator of the Alerts engine, permitting massive system scalability. The decoupled architecture allows for the passing of an anonymous request to third party providers, thereby distributing the intensive processing and bandwidth required for gathering content. The content service can be effectively outsourced to providers that have particular expertise or time-critical access to certain required content. In the case of time-critical alerts, for example, the distributed architecture permits tapping multiple content providers simultaneously in order to increase the opportunity to receive the desired information as quickly as possible. Additionally, by passing requests to the content providers that are customer-anonymous, the identity and privacy of the Alerts customers can be protected.

The decoupled Alerts delivery functionality permits outsourcing of the delivery service to different distribution channels, thereby providing the bandwidth needed for a robust and reliable Alerts system able to handle millions of Alerts. Another advantage realized from the distributed architecture is the ability to send the same alert information to different customer devices or terminals according to schedule. For instance, a customer can specify delivery of an alert via email at 9 am, and via SMS at noon.

By dissociating the what/when/where elements of the greater alerts service, another benefit is provided by aspects of the invention in that a consistent and familiar user experience is offered to the alerts customers, regardless of which third party content provider or distribution channel is utilized to actually fulfill each distinct alert. For instance, with a single customer account maintained by the alerts engine, a customer can request all desired alerts, set the parameters for each alert's content, and set the delivery options for each alert using a single Web-based interface. In one example embodiment, multiple different alert definitions and configurations can be viewed or edited via a single screen, even though different content providers are utilized to fulfill the various alerts.

Another feature made possible by aspects of the invention is the maintaining and building of user profiles by the alerts engine, and anonymously coupling the serving of highly-relevant advertisements to the scheduling and distribution functionalities of the alerts system. Accordingly, the alerts service can be offered as a free service to customers, sponsored by advertising. The use of anonymous individual user profiling permits highly-relevant advertisements to be served to customers having a high probability of interest in the advertised goods or services. For instance, specially-selected or even specially-tailored advertisements can be attached to individual alerts. Utilizing a system architecture according to aspects of the invention, customers can be assured that their personally-identifying information will be kept secret from advertisers; while advertisers can be assured that customers will be receiving highly-relevant advertisements.

Another feature made possible by aspects of the invention is the tailoring of the specific distribution channels to the functionality and requirements of an alert. For example, a “wake up” alert would only be proposed to users using a phone call distribution channel as a text message or email is unlikely to perform the function of the alert: waking up the user. Similarly, with the limitations on SMS/Text Message of 160 characters, long form content isn't suited for this delivery channel and can thus be omitted from the choices of delivery channels.

In one arrangement, the alerts engine interfaces with each of the alerts agents and the distribution channels by exchanging specialized data structures corresponding to individual alerts that define the key elements of that alert. In one example embodiment, the specialized data structure is a tagged data file, such as an eXtensible Markup Language (XML) file.

### Search

Aspects of the present invention substantially satisfy the need within the advertising industry for improving user-targeted advertising by providing a system and method of increasing available advertisement inventory through customizable electronic alerts that can be modified based upon user acceptance of suggestions to receive additional relevant or complementary information. The alerts delivered to a user can contain information relating to various criteria of the initial alert configuration, or inferred based upon the user's initial subscription to the alert.

The criteria can be provided directly by the user or in response to suggestions previously provided to or by the user.

The alert subscription is typically generated by an initial user request or search that is atomic in nature, or based upon a specific and definable element of information. Each atomic element relates to a discrete subject matter, such as, for example, flight availability, flight status, or pricing information. The initial atomic element can be used to infer how multiple atoms can be linked together to form “molecules” of information such that a single information request can lead to a user requesting corollary information related to the first atom. For example, from a user request for flight availability or pricing information between two cities the alert system of the present invention could infer a need to provide notification regarding, for example, the availability of special deals at the destination, traffic conditions at the airport, a designated user charged with meeting the traveler at the airport, flight status, or weather at destination.

In one embodiment, a user can configure the system to receive an alert containing one atom or construct a molecule made up of pre-selected atoms. In another embodiment, a user can configure the system to receive an alert containing one or molecules dynamically generated based upon logical associations among atoms. In a further embodiment, a user can configure the system to receive an alert containing one or molecules dynamically generated based upon inferences from the user habits and preferences. In a further embodiment, a user can configure the system to receive an alert containing one or molecules dynamically generated based upon inferences from like users habits and preferences. In an additional embodiment, a user can be exposed to the opportunity to configure new alerts when receiving the results of an atom- or molecule-based alert containing dynamically generated inferences to other alerts.

The linking of atoms to form molecules of information can be accomplished in a number of ways. In one embodiment, a system automatically generates the initial molecule and links additional atoms or removes existing atoms. In another embodiment, a system links additional atoms or removes existing atoms only upon request by a user. In a further embodiment, a system prompts a user with suggestions for linking additional atoms or removing existing atoms and modifies a molecule in accordance with the user's response.

### RSS Content

Aspects of the present invention substantially meets the aforementioned opportunity of providing a system and method for increasing the opportunity for users to consume RSS feed content without the drawbacks of information overload by suggesting to users to pre-define the type of content they wish to receive (news, sports, weather, etc.), the specific type of content they are interested in (2008 elections, Red Sox scores, tornado in Mississippi), eventually the source of content they trust (CNN and Wall Street Journal, ESPN and Sports Illustrated, Weather Channel and Government sources, etc.), when they would like to receive that information and signing-up to receive relevant customizable alerts. The defined alert would be indexed against a series of RSS feeds and only the specific content pertaining to the user requested information would be returned to the user.

The Alerts.com RSS infrastructure acts as the Reader and the business logic of the RSS Alerts API helps extract out of the Alerts.com RSS Infrastructure exactly the content a user requested. The Alerts.com platform then allows that user requested content to be pushed to users, on their terms and in the context of their lives. The Alerts.com RSS Alerts API is the fastest way to create and publish alerts on the Alerts.com platform. As its name indicates, it leverages RSS as the source for the alert information. RSS or real simple syndication is a document (often called a “feed,” “web feed,” or “channel”) which typically includes full or summarized text plus metadata such as publishing dates and authorship. A standardized XML file, residing in a Web server, allows the information to be published once and viewed by many different programs.

Web feeds benefit publishers by letting them syndicate content quickly and automatically. They also benefit readers who want to subscribe to timely updates from favored websites or to aggregate feeds from many sites into one place.

RSS feeds are typically read using software called an “RSS reader,” “feed reader,” or an “aggregator,” which can be web-based or desktop-based. The user subscribes to a feed by entering the feed's link into the reader or by clicking an RSS icon in a browser that initiates the subscription process. The RSS reader checks the user's subscribed feeds regularly for new work and pulls the information every x number of minutes from the server, downloads any updates that it finds, and provides an interface to users to monitor and read the feeds. Users are thus required to go to their reader for any updates.

In one embodiment, the Alerts.com RSS infrastructure acts as the Reader while the business logic of the RSS Alerts API helps extract out of the Alerts.com RSS Infrastructure exactly the content that a user requested. The Alerts.com platform then allows that user-requested content to be pushed to users, on their terms and in the context of their lives.

### BRIEF DESCRIPTION OF THE DRAWINGS

The embodiments of the present invention may be more completely understood in consideration of the following detailed description of various embodiments in connection with the accompanying drawings, in which:

FIG. 1A-1C illustrate exemplary alerts systems according to an embodiment of the present invention.

FIG. 2A-2B illustrate an exemplary alert instance in XML format according to an embodiment of the present invention.

FIG. 3A-3C illustrates an example of the set up of the alert defining a schedule conflict resolution algorithm according to an embodiment of the present invention.

FIG. 4 illustrates an example of an alert markup language (AML) file according to one embodiment of the present invention.

FIG. 5A-5G illustrates examples of variations to the system architecture according to various embodiments to accommodate different degrees of scaling.

FIG. 6 is a block diagram of an alert system according to an embodiment of the present invention.

FIG. 7 is a diagrammatic illustration showing construction of a molecule from atoms according to an embodiment of the present invention.

FIG. 8 is a flowchart illustrating processing steps in an alert system according to an embodiment of the present invention.

FIG. 9 is a flowchart illustrating processing steps in an alert system according to an embodiment of the present invention.

FIG. 10 is a flowchart illustrating processing steps in an alert system according to an embodiment of the present invention.

FIG. 11 is a diagrammatic illustration showing the output of an Alert created using a weekly date picked as the schedule type according to an embodiment of the present invention.

FIG. 12 is a diagrammatic illustration showing the user experience in a produced AML according to an embodiment of the present invention.

FIG. 13 is a flow chart illustrating the identification of the origination of the embedded hyperlink according to an embodiment of the present invention.

FIG. 14 is a flow diagram illustrating associating the UII with the user requested email by the service provider to associate events occurring subsequent to the serving of the advertisement with the particular user requested content email according to an embodiment of the present invention.

FIG. 15 is a flow diagram illustrating the dynamic conversion of a text ad to be an image of the text ad while serving as SERVER images according to an embodiment of the present invention.

While the present invention is amenable to various modifications and alternative forms, specifics thereof have been shown by way of example in the drawings and will be described in detail. It should be understood, however, that the intention is not to limit the present invention to the particular embodiments described. On the contrary, the intention is to cover all modifications, equivalents, and alternatives falling within the spirit and scope of the present invention.

### DESCRIPTION OF THE PREFERRED EMBODIMENTS

### Alerts

An alerts system according to aspects of the invention automatically gathers and delivers user-requested content. The content can be categorized as alerts, notifications, and reminders. An alert is something that happens and that we don't know about until its occurrence. For example, when there is a tornado, an alert is generated. For these events, the “when” or the “what” is unknown a priori. Notifications are generated based on schedule (for example every day or every week). Examples of notifications include horoscopes, daily news updates, and Gas Price notifications. In this case, we don't know the content, but we know when we will have access to the information. A reminder is something that helps the customer remember something. For the reminder we know the “what,” and the “when.” For the sake of readability, all three types are collectively referred to herein as alerts.

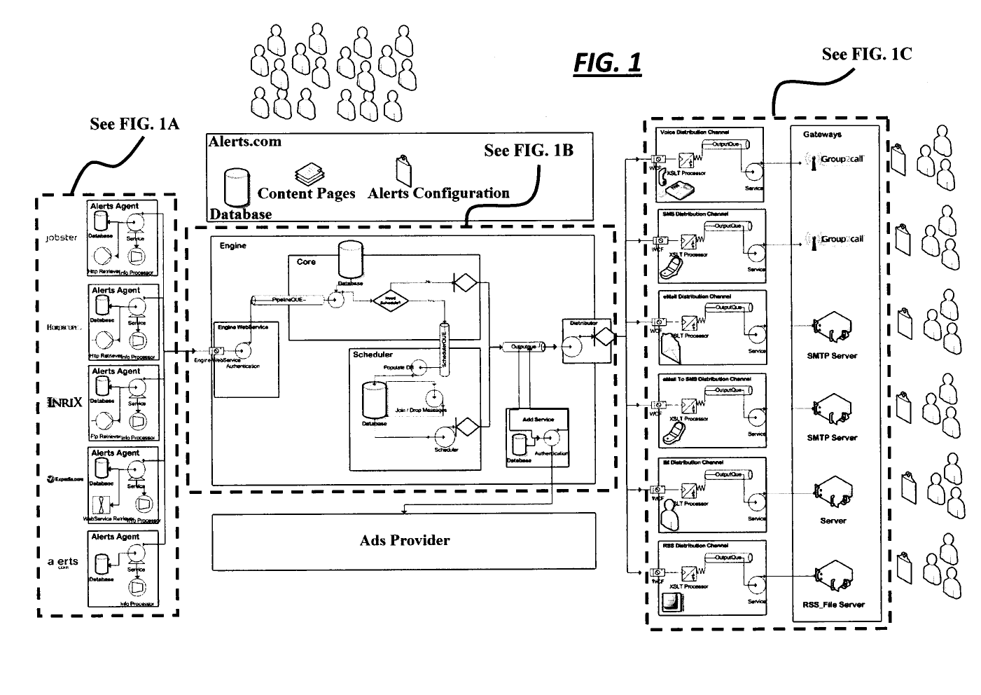

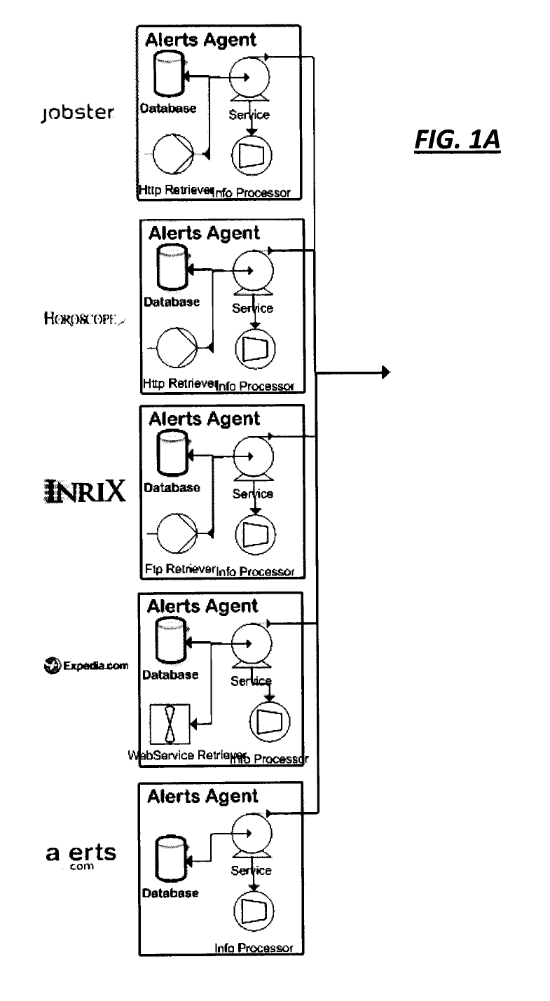

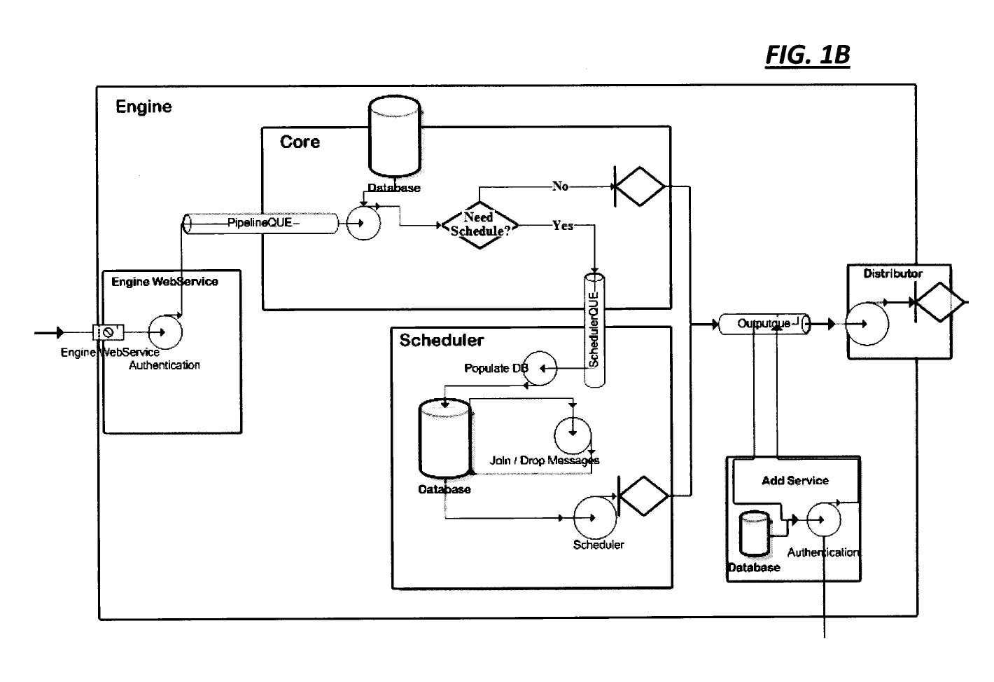

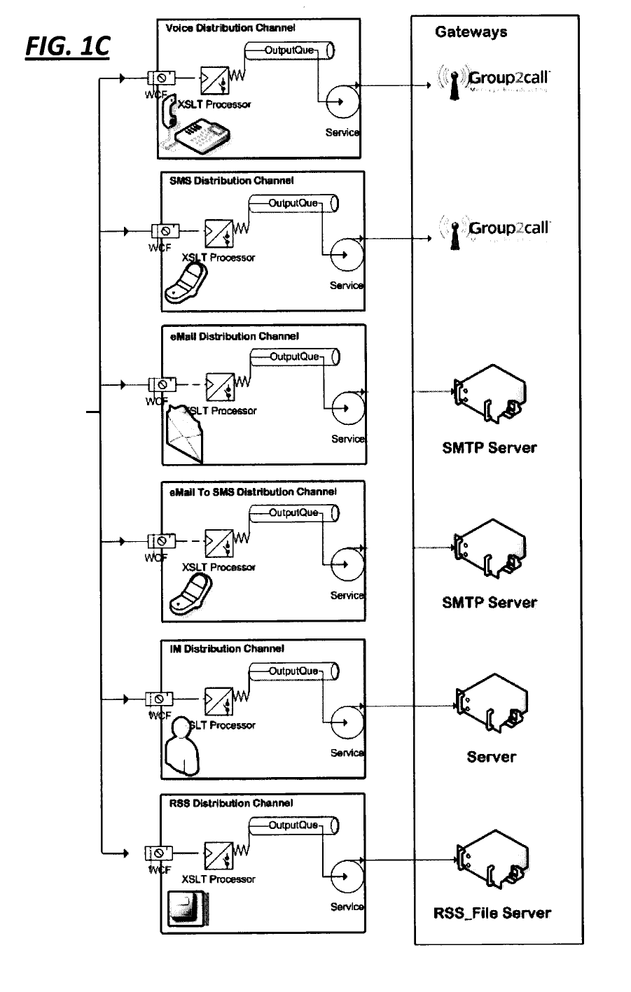

FIG. 1 is a diagram illustrating an alerts system according to one embodiment. The system includes an alerts engine, a plurality of alerts agents, and a plurality of distribution channels. The alerts agents are communicatively coupled with providers who supply the contents of the alerts. The distribution channels are communicatively coupled to customers receiving alerts. The alerts engine interfaces with customers and with the alerts agents, distribution channels, and with advertisers. In order to receive these alerts the customer configures and authorizes each one of the distribution channels. Next, the customer sets up the alerts via the alert configuration interface (ACI). These steps are facilitated by a customer interface of the alerts engine. A Distribution Channel (DC) is a service that uses a User DC identification (UDCI) to send the customer a message in different forms. For example in the case of the email distribution channel, the UDCI is the customer's email address, in the case of voice DC is the customer's telephone number. The customer is given the option to schedule when and where he or she will receive each instance of an alert via an alert Schedule-DC Configuration (ASDC).

The alerts providers have access to the information that is needed to generate each alert. Each provider has an interface that is based on a set of parameters. For example, in the case of gas price notifications, the set of parameters are the zip code and the type of gas. In the case of horoscopes, the parameter is the simply the sign (Aries, Gemini, Taurus, etc). These sets of parameters are referred to herein as the Alert Interface (AI).

In the AI, each parameter has a name and a type. For example, in the case of gas price notifications, the parameters are the customer-specified zip code and type of gas. The zip code is a numeric field of 5, and the type of gas is a character of 10. The AI also supports collections of multiple distinct values for a given parameter or set of parameters. The collections may be represented as N rows of an internal parameter set. For example, in the case of birth date reminders, there is a collection of rows that is used for every person's birth date.

In certain embodiments the alerts system allows for a fully configurable ASDC and AI. To support this functionality, the alerts system includes a user interface (UI) that provides the user configuration options. Each configurable parameter in the AI and the ASDC utilizes one or more UI components. Common UI components include a TextBox, a CheckBox, a ListBox, and a DropDownList. One having skill in the art will recognize that various embodiments of the present invention will utilize UI components present in the Java AWT library, .NET library, standard HTML markup and the like. The UI may also utilize custom Web controls in configuration of the AI and ASDC. Various embodiments of the present invention utilize extensible markup to represent various UI components, custom controls and configuration data. The markup used in conjunction with the AI, the ASDC, and the UI components is referred to herein as the Alert Markup Language (AML). One having skill in the art will recognize that AML may implement the semantic constraints of XML.

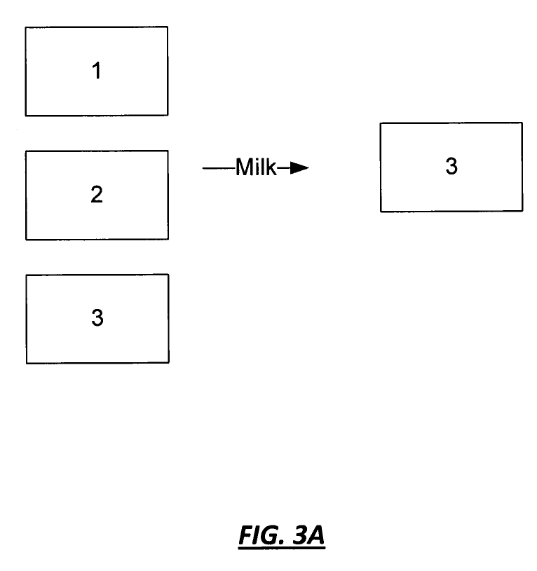

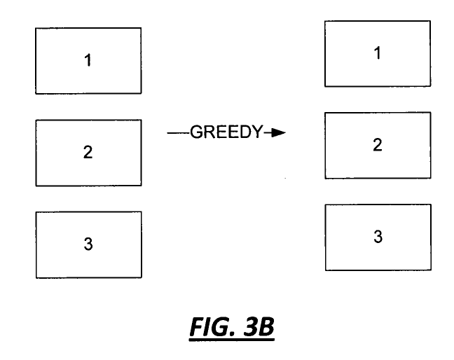

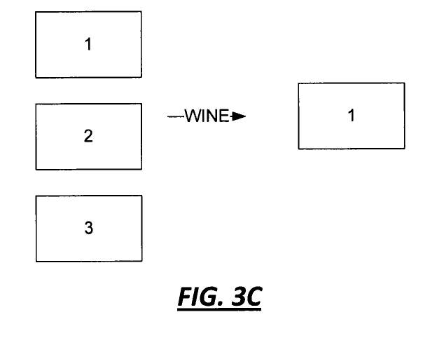

As part of initially configuring the system to work with a new provider, the provider establishes a system interface with the alerts system operator (e.g., alerts.com). In order to do this, the provider either creates an Agent by creating a specific application programming interface (API) with the system operator, or the provider may provide the data or API to the system operator, so that the system operator can create the corresponding agent. Under the agreement, the provider and the system operator determine the AI, ASDC and components that will be used. All this information is written in AML. In the case that the alerts support or require scheduling, the set up of the alert will define a schedule conflict resolution algorithm, an example of which is described below with reference to FIGS. 3A-3C.

In certain embodiments, a customer configures an ASDC, by configuring an alert instance utilizing the AI configured by a provider registered with the alert system. For example, if a user would like to configure a Horoscope report, the AML for the Horoscope alert provider AI will display the appropriate UI components to allow the user to select report parameters in the alert system user interface. The customer may then submit the ASDC to the alert system. In certain embodiments, once the ASDC is submitted to the alert system the ASDC is forwarded to the alert agent which will then provide the alert according to the parameters set by the customer. In certain embodiments the ASDC is a XML message of parameters specified in the AI. In related embodiments the ASDC is a session object which is then marshaled into an XML message for transport. One having skill in the art will appreciate the various methods of receiving configuration data from a user interface and creating a deliverable message therefrom. In this way, a user may configure several different alert subscriptions from various alert providers.

In order to receive alerts from different providers, certain embodiments of the invention utilize an Alerts Simple API (ASAPI). ASAPI is an improved approach over the known OASIS Common Alerting Protocol (CAP). In CAP, the attributes are fixed; whereas in ASAPI, the attributes are dynamic. Each alert is different in nature, in systems according to certain embodiments, the language of each alert can have a different alert configuration interface (ACI). Thus, for example, for a weather alert, the interface can be the ZIPCODE and the type of event (TORNADO, FLOOD, ETC); while in a horoscope ALERT, the interface can simply be the zodiac sign. Accordingly, when a provider needs to notify the alerts system operator about an alert, the provider will populate the ACI with the appropriate values.

The alerts system depicted in FIG. 1 has a fully distributed architecture. The architecture separates the agents (providers of information), the engine, and the distribution channels. Each of these is shown in greater detail in FIGS. 1A, 1B, and 1C, respectively.

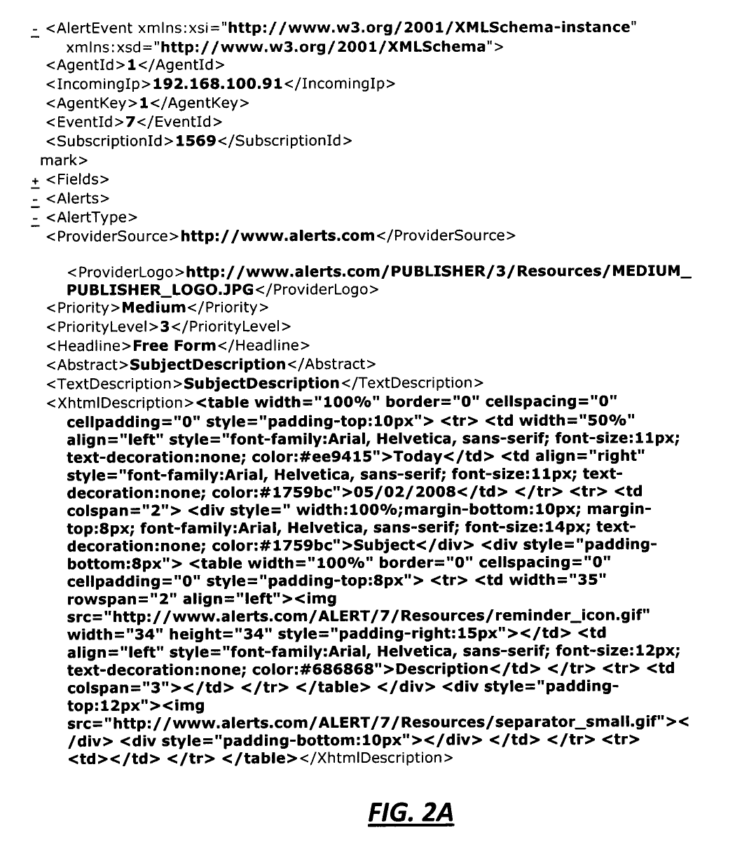

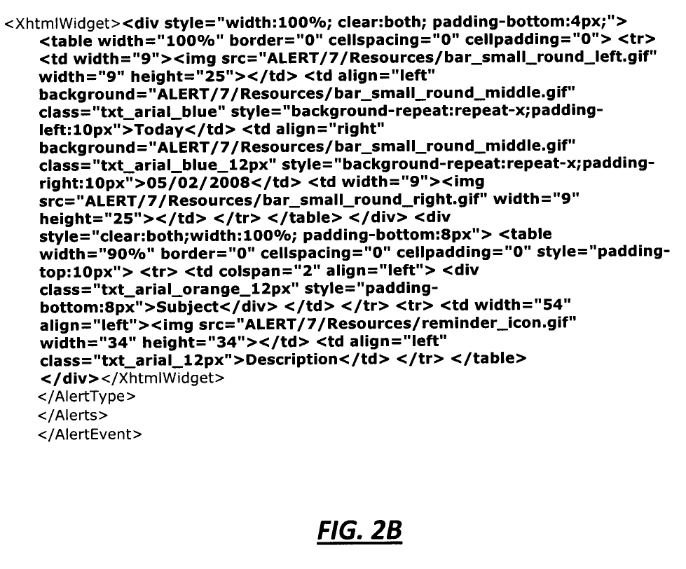

Each agent (for example weather agent) is responsible for generating the alerts for each subscription. The agent doesn't know which customer wants to receive what alert, or when, but it knows what parameters the customer is interested in (via the subscription or AML Instance). Based on the parameters determined in a customer's ASDC each agent will generate an alert instance. In certain embodiments the alert instance is represented by an XML message. FIGS. 2A and 2B illustrate an exemplary alert instance in XML format. The alert instance contains the name of the parameter with the current value; for example, in the case of weather, the agent would receive an alert instance that identifies the ZIPCODE and the value of the zip code (for example 98034). In certain embodiments the returned parameters have additional markup to determine formatting characteristics of the endpoint. In alternative embodiments a parameter may be repeated in the alert instance accompanied by additional markup to enable more efficient viewing on a variety of target platforms. For instance, an alert instance may include a parameter formatted for delivery over the web and a duplicate parameter formatted for SMS delivery.

If there is suitable data available in order to generate an alert for a specific subscription, then the agent will create an alert event(ALERT_EVENT). The alert event may be an XML message which includes the relevant parameters as determined in the customer's ASDC. As shown in the XML in FIGS. 2A-2B, there is no information on how to contact the customer directly. This is because the agent doesn't need to know who wants to receive this alert, where or when. In certain embodiments the agent constructs the alert event and forwards it to the alert system engine.

Once the alert gets into the engine (Engine WebService), the first task that the engine performs is it loads all of the information about the customer, subscription and alert. The goal of the task is to identify if the customer wants to receive the alert as soon as possible, or if the customer wants the alert to be scheduled for delivery at a certain time. In certain embodiments the alert event message is transformed into objects (demarshaled) for use in the engine. In alternative embodiments the engine will retain the alert event in original form, such as XML.

If the customer has requested to receive the alert ASAP, then the engine retrieves distribution information on how the customer wants to receive the alert (for example by SMS, EMAIL or VOICE), and the User DC identification (UDCI) (e.g., the email address, or user's telephone number). The Core puts all this information in an XML message the XML and sends this to the engine distributor. The engine distributor will send the alert to the distribution channel. In certain embodiments a new XML message is created by marshaling the object data into an XML message and forwarded to the engine distributor. In alternative embodiments the alert event XML message is edited and forwarded to the engine distributor. One having skill in the art will recognize the various tools and packages available for interrogation, modification, transformation and marshal/demarshal of XML including DOM, SAX, XSLT and the like.

If the alert needs to be scheduled, then the engine sends the alert to the scheduler. The task of the scheduler is to determine when the user wants to receive the alert (e.g., every Monday at 8 AM). If needed, the scheduler calculates the time difference between the customer's local time and the server time. It's possible that the agent sends more than one alert between schedules, in this case there is alert schedule conflict. This conflict is resolved using the schedule conflict resolution algorithm (SCRA). The type of algorithm used will depend on the type of alert. FIGS. 3A-3C illustrate and explain examples of conflict resolution algorithms called Milk, Greedy, and Wine, respectively.

Once the alert is ready to be sent (in the scheduler), the alerts engine pulls the alert from the scheduler and sends the alert to the distributor. The distributor is responsible for sending the alert to the distribution channel.

The distribution channel does not know anything about the customer, alert, or subscription. The only responsibility of the distribution channel is to send the alert based on the content of the XML and the User DC identification (UDCI). Each distribution channel will send the information formatted in different way, for example an SMS needs to be limited to 160 characters. HTML email will contain html, voice will contain only text. Each DC will receive the same information from the engine that is the ALERT EVENT XML, but they will transform this xml into the channel required format using XSL Transformations.

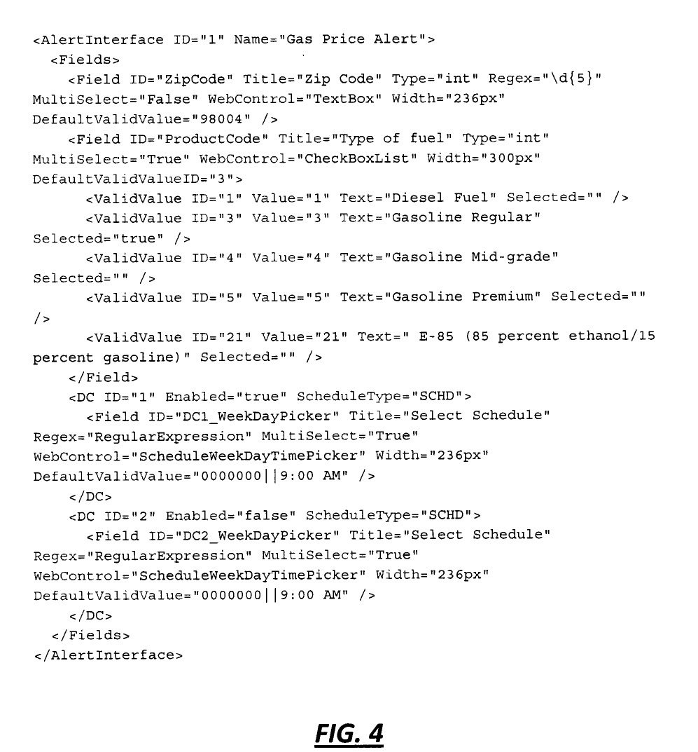

An example of an alert markup language (AML) file according to one embodiment is shown in FIG. 4. The root node of the document contains the ID of the Alert Interface (AI) that corresponds to the primary key identity of the Interface as described in the Interface table in the Alerts database. The name attribute of the root node corresponds to the name field of the Interface record in the table for this entry. The first child of the Alert Interface node is the “Fields” node. This element can have only 2 types of children but of these types there is no hard limit. These types are “Field” and “DC.” A Field at the child level of the Fields element will translate into a direct input field that will be generated at runtime for user input. A DC, which stands for Distribution Channel, will render an input widget to the user designed for the scheduling of the alerts subscription.

A Field element also referenced as an input field includes certain attributes in order to render correctly. These are: ID, Title, Type, WebControl. The ID must by unique for each field. The title is the caption for the input field. The type is the primitive datatype that will be used by this field, i.e., int, string, bool. Optional attributes that can be supplied are: DefaultValidValue, DefaultValidValueID, Regex, Multiselect, Width.

The DefaultValidValue contains the default value that will be supplied in the input control. The DefaultValidValueID attribute represent the ID of the ValidValue child element (if supplied) that will be selected. Regex is the attribute that will contain the regular expression that one would like supplied to validate the corresponding input field. Multiselect indicates wither the control has multiple items selected this attribute is associated to also supplying a series and child ValidValue elements. The Field element can have only 1 type of child and it is optional and this element is the ValidValue element. One can supply as many elements of this type as they wish and the elements will be rendered as options to the corresponding control. The ValidValue element contains 4 required attributes these are: ID, Value, Text, Selected.

The Distribution Channel element is used to describe what input fields will be rendered to the user for scheduling there instance of an alert subscription. The “DC” element itself has 3 attributes which are required these are: ID, Enabled, and ScheduleType. The ID attribute describes the ID of the Distribution Channel to be used these are Constants ids and do have a Fixed association. The Association is as follows:

1 Email

2 SMS

3 Voice Cell Phone

4 Voice Home Phone

5 Voice Work Phone

6 Fax

7 Live.

It should be understood that this is not a comprehensive list, and can be extended as support for more distribution channels is added. The Enabled attribute specifies wither or not the distribution channel is enabled by default. The ScheduleType specifies the scheduling type for the associated DC the default value is “SCHD”. The DC Element contains only 1 child type and that type is “Field”. The same rules of the Field element apply here as well; however there are some rules in place that have been implemented in order to allow for rich customization of scheduling input elements. In the above example, it should be noted that the use of ScheduleWeekDayTimePicker control, which is a custom composite control that was created specifically to all the scheduling input of both weekdays and at a specific time. A series of scheduling controls have already been created for the WWW based Interpreter of the AML language. Examples of these controls include:

ScheduleASAPPicker

ScheduleDatePicker

ScheduleDateTimePicker

ScheduleTimePicker

ScheduleWeekDayPicker

ScheduleWeekDayPicker

ScheduleWeekDayTimePicker.

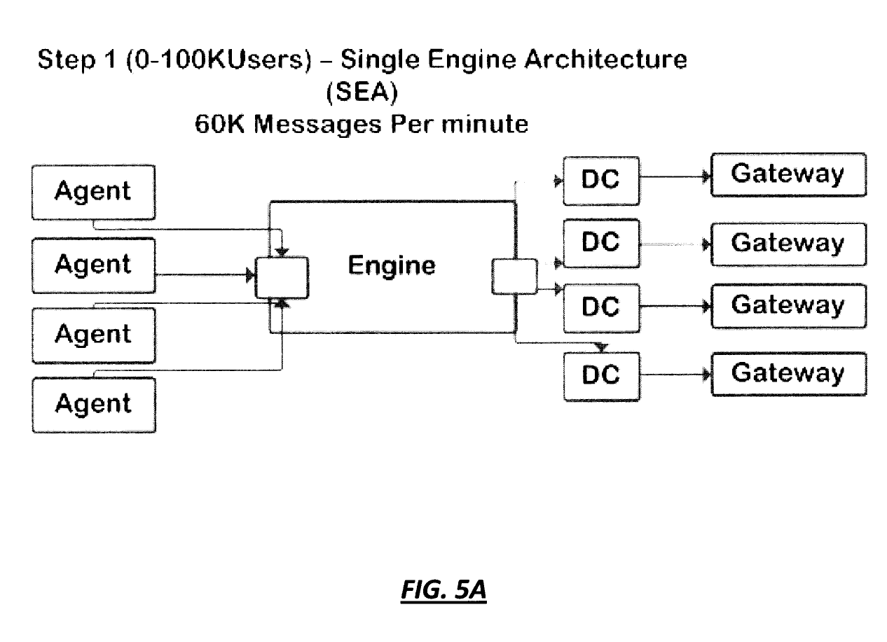

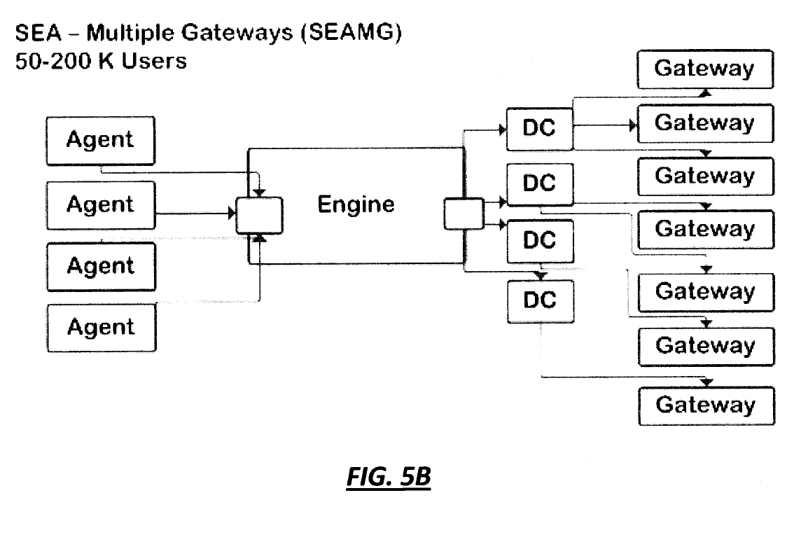

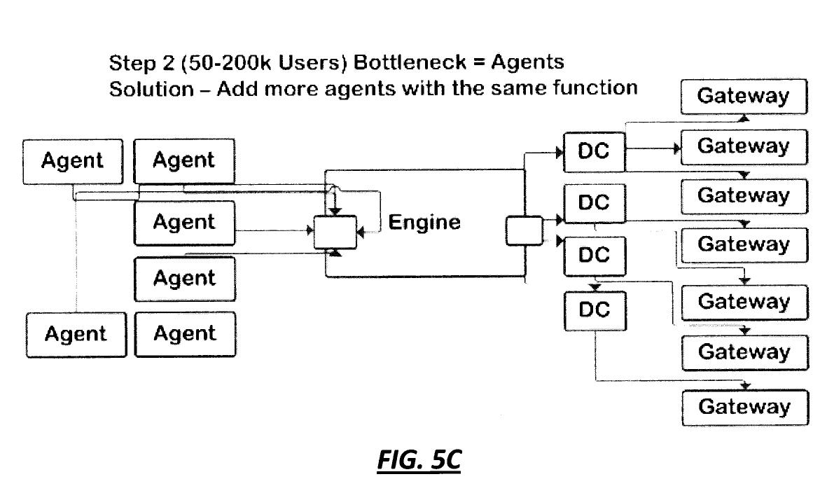

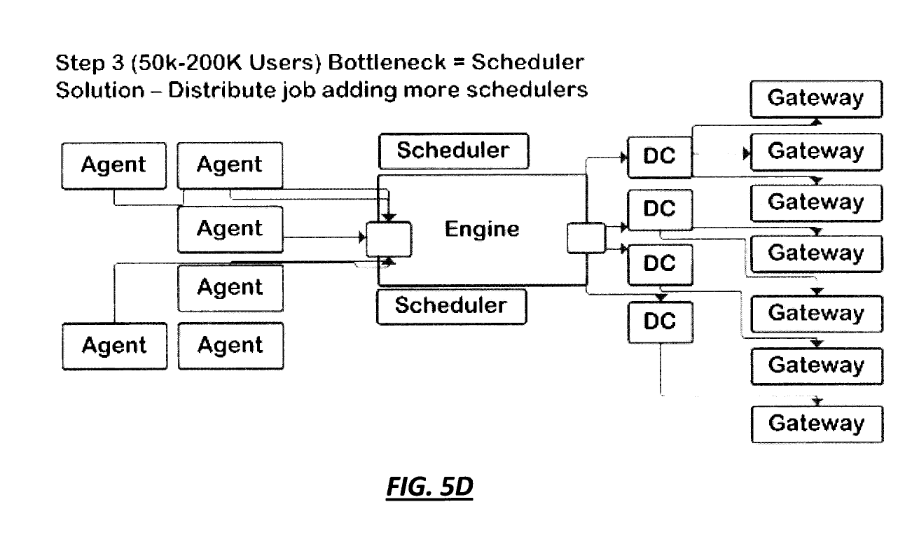

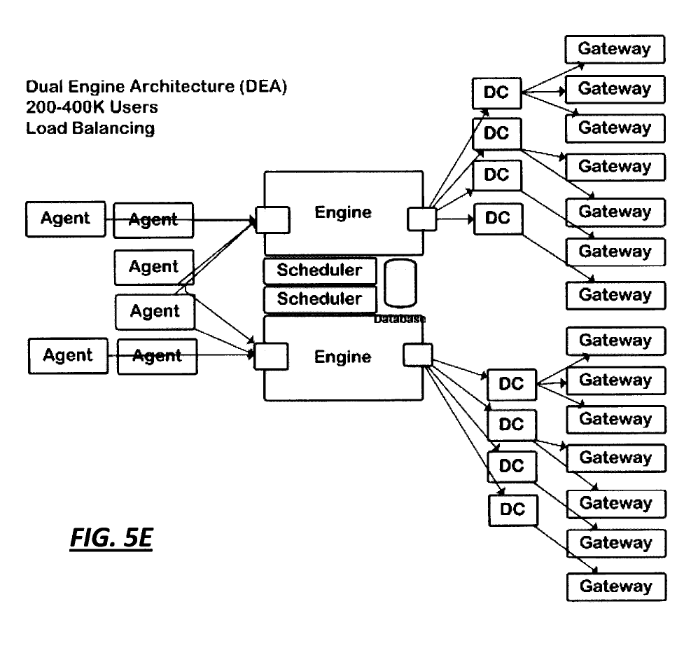

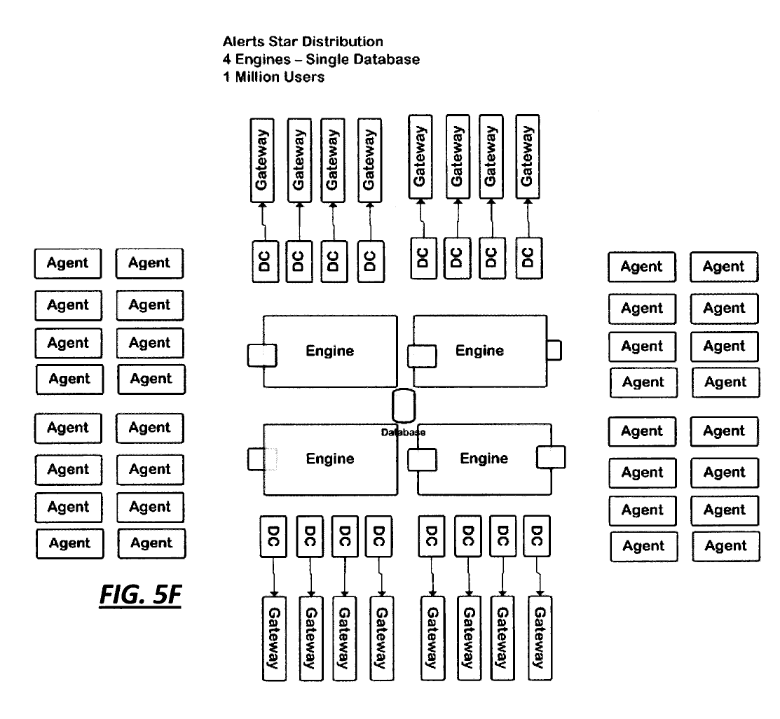

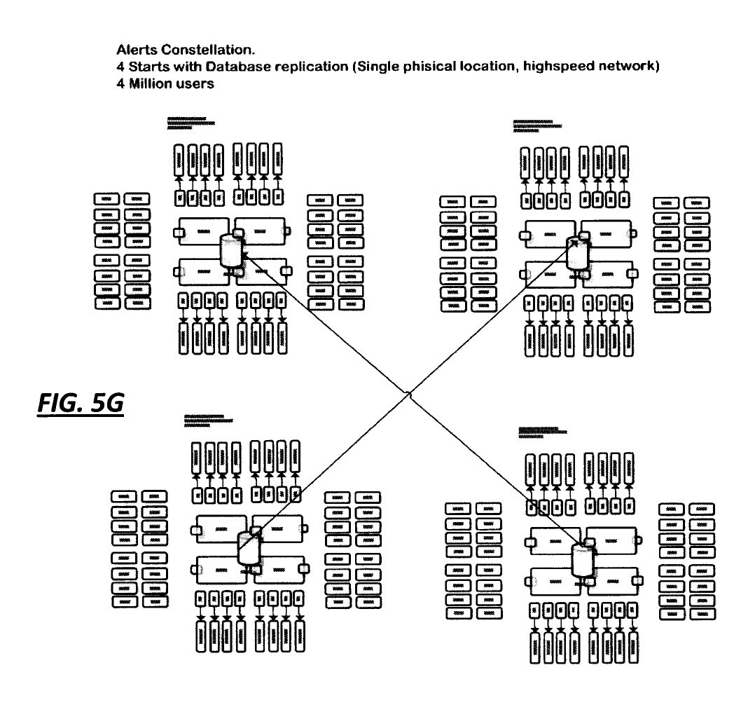

FIGS. 5A-5G illustrate examples of variations to the system architecture according to various embodiments to accommodate different degrees of scaling. FIG. 5A illustrates a basic single engine alerts system configuration capable of supporting up to 100,000 users. FIGS. 5B-5D illustrate various adaptations to a system for handling generally 50,000-100,000 users. FIG. 5B illustrates an example embodiment in which there are multiple gateways per distribution channel to improve the alert delivery bandwidth of the system. FIG. 5C illustrates a further adaptation to address situations where the alerts agents constitute a major bottleneck. In the embodiment of FIG. 5C, there are multiple agents performing the same function. Advantageously, more bandwidth is provided. In this embodiment, a servicing of an alert can also be sent to multiple agents simultaneously to improve time-critical performance for certain alerts. The embodiment of FIG. 5D illustrates an alerts engine with multiple schedulers to distribute the scheduling function.

FIG. 5E illustrates a configuration of an alerts system in which there are multiple alerts engines and a load balancing provision to facilitate optimal overall performance. This configuration is generally capable of supporting 200,000-400,000 users. FIG. 5F illustrates a system that is further expanded with additional alerts engines to handle up to 1 million users. FIG. 5G illustrates a scaled up constellation topology having the alerts engine database replicated at multiple locations.

### Search

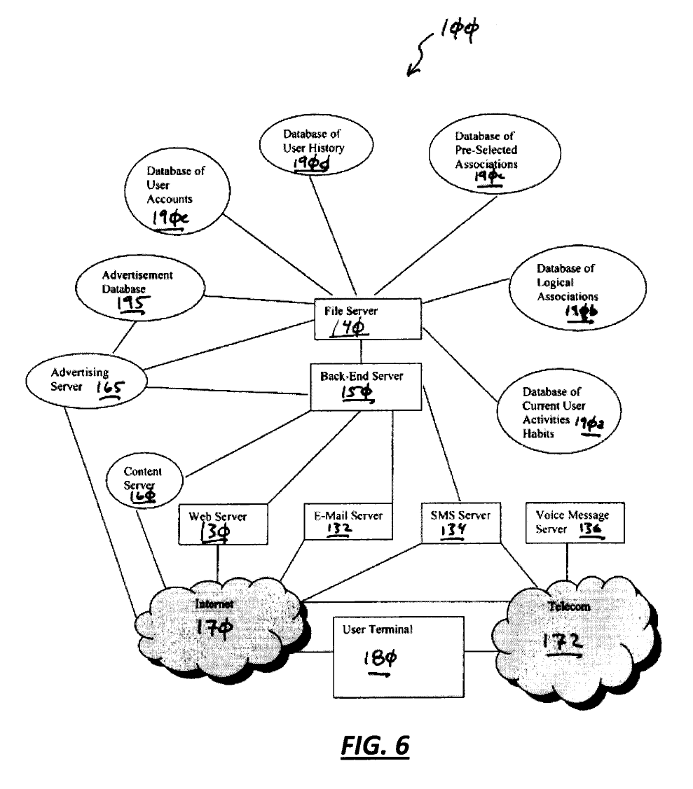

An alert system for providing customized alerts to users is depicted generally in FIG. 6 with reference numeral 100. Alert system 100 can generally associate different subject matters and deliver information to a user relating to the various associated subject matters, placing appropriate contextual or content-specific advertisements embedded within the delivered alert.

Although any number of network configurations may be suitable to implement aspects of the invention, an example embodiment is depicted schematically in FIG. 1. Web server 130, back-end server 150, content server 160, and user terminal 180 generally interface through network 170 such that web server 130, back-end server 150, content server 160, and user terminal 180 are in communication with each other. File server 140 generally communicates with back-end server 150 and databases 190a-e.

In one embodiment, back-end server 150 is responsible for coordinating the operation of alert system 100. Back-end server runs system software that controls data flow between the different servers or modules. Back-end server 150 may also provide a user interface that allows the overall operation alert system 100 to be maintained and managed as needed. Back-end server 150 also executes an alerts system program that provides alerts for users. The alerts system program includes instructions for maintaining user accounts associated with user preferences, a list of specific alert definitions for alerts subscribed to by the user, alert delivery options selected by the user, and instructions for constructing combinations of individual alerts having a useful relationship with one another. Individual alerts are referred to herein as atoms, while related groupings of alerts are referred to herein as molecules.

In one embodiment, file server 140 manages databases 190a-e. Databases 190a-e generally contain information relating to atoms 110 and their corresponding subject matter, pre-formed and customized molecules 120 and their corresponding subject matter, and users. In this manner, back-end server 150 can manage the information provided to a user based upon information received from user terminal 180 in accordance with operations instructions. Such management includes, for example, the modifications of existing molecules 120 in accordance with user preference and the creation of new molecules for new users.

Content server 160 is responsible for obtaining current information from various sources for fulfilling individual alerts. Back-end server 150 obtains the current information from content server 160, and constructs the individual atoms and molecules for delivery to the user at terminal 180. In this manner, information relating to the atoms selected by a user can be constantly updated such that when relevant new information is gathered, back-end server 150 can immediately provide for the construction and transmission of a new electronic transmission.

Advertising server 165 interfaces with computer systems operated by various advertisers via the Internet 170 to obtain ads that are to be incorporated into the alerts. Advertising server 165 also manages advertisement database 195, which stores the various advertisements and their associations with different alert types. Back-end server 150 obtains the advertisements from advertising server 165 and constructs the alert atoms with advertisements that are relevant to each specific type of alert.

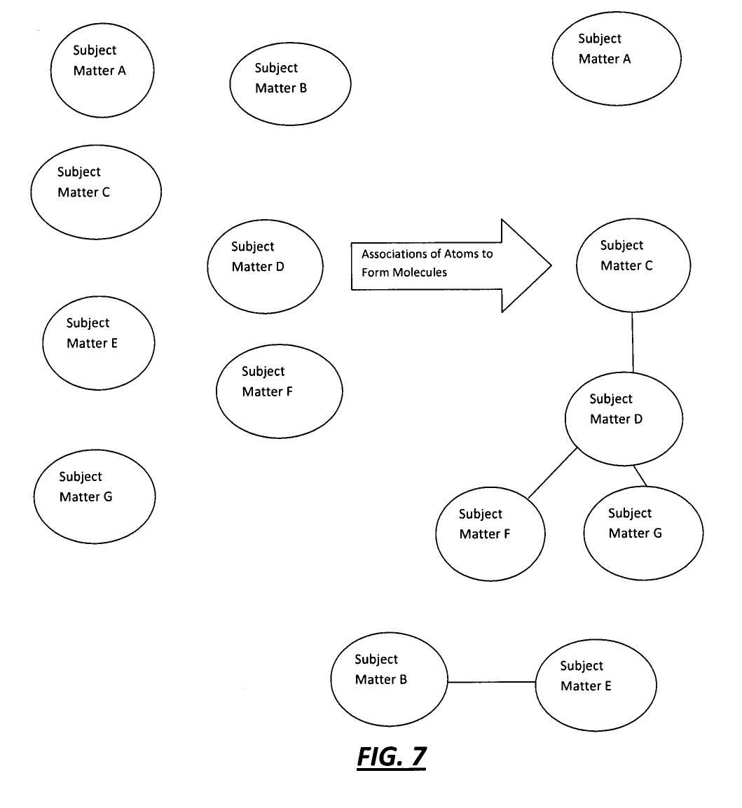

Referring to FIG. 7, different subject matters for alerts are depicted as atoms 110, which can be associated such that a molecule 120 made up a plurality of atoms 110 and can be delivered to the user to provide various types of information. Each atom 110 generally corresponds to distinct subject matter for an alert. For example, in one type of embodiment, each atom 110 represents an individual alert. When various atoms are linked, a single molecule 120 can correspond to a plurality of subject matters, as depicted in FIG. 2. In a related example embodiment, each molecule 120 represents a set of individual alerts that are delivered to a subscriber together, such as in a single email.

In general, the associations between atoms 110 are not random. Rather, associations between atoms 110 are generally based upon algorithmic criteria, user preference, or a combination thereof Such algorithmic criteria may, for example, correlate or differentiate subject matters based upon system-defined or user-defined relevancy scores or logical associations between atoms or molecules, and inferred activities associated with certain other atoms or molecules. In this manner, molecule 120 can be constructed to have information likely to be considered useful by the user.

For example, the subject matter depicted with the letters A-F in FIG. 2 may correspond to subject matter as follows:

TABLE 1

| Letter | Subject Matter |
|---|---|
| A | Weather |
| B | Sports scores |
| C | Hotel Availability |
| D | Car Rental Prices |
| E | Airfare |
| F | Gasoline Prices |
| G | Sporting Events |

The result of the association of atoms 110 is three distinct molecules 120. The first molecule 120a represents information relating to weather. The second molecule 120b represents information relating to hotel availability, car rental prices, airfare, and gasoline prices. The third molecule 120c represents information relating to sports scores and sporting events.

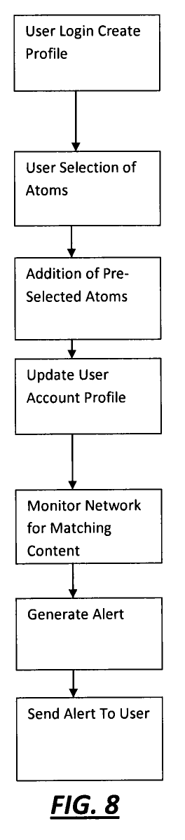

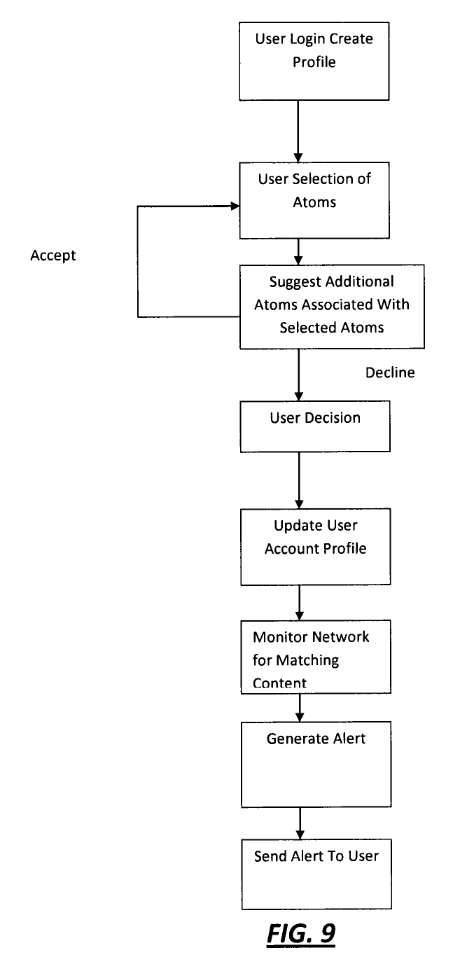

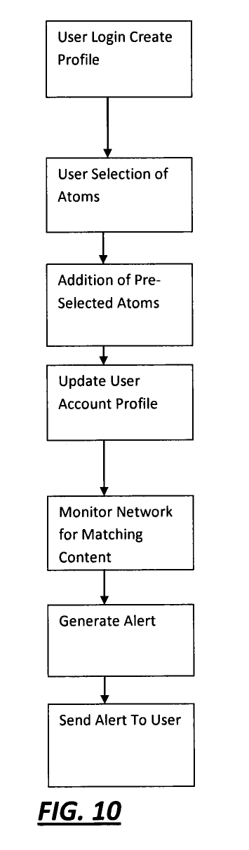

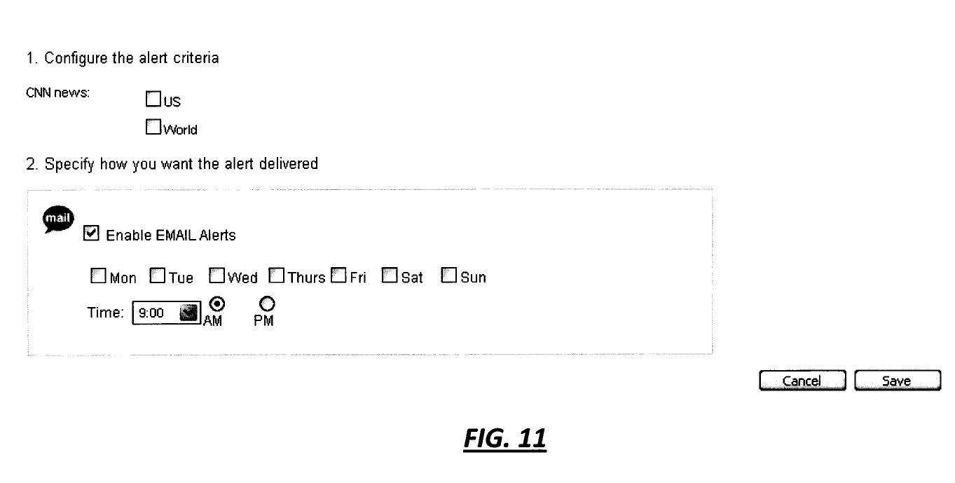

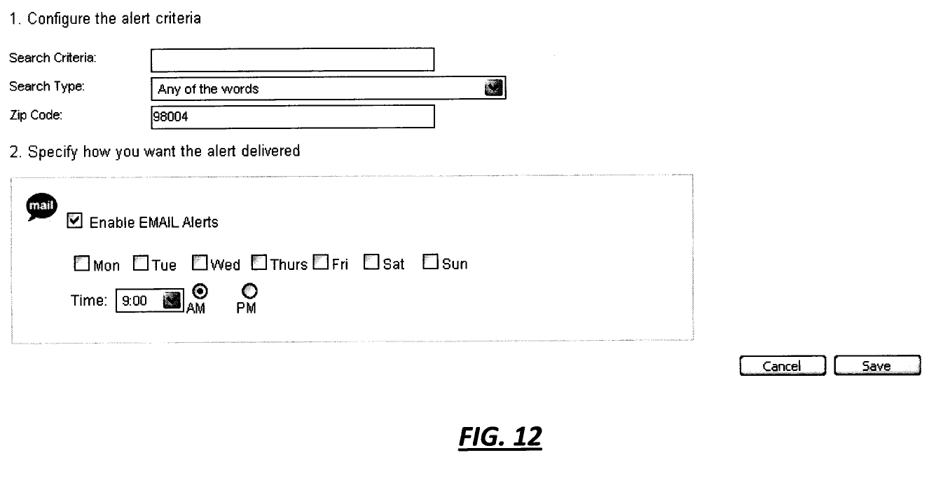

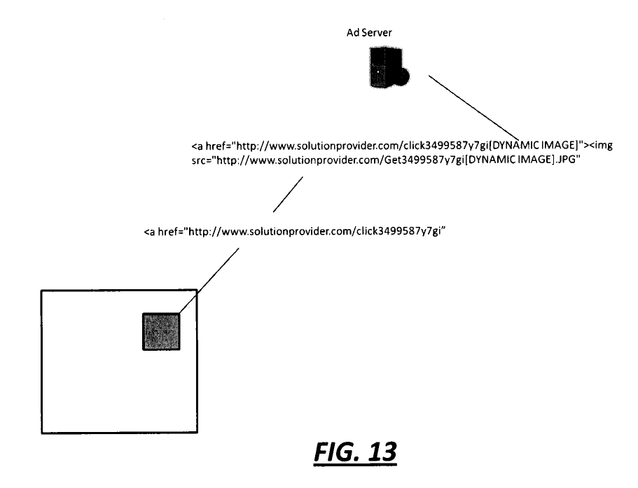

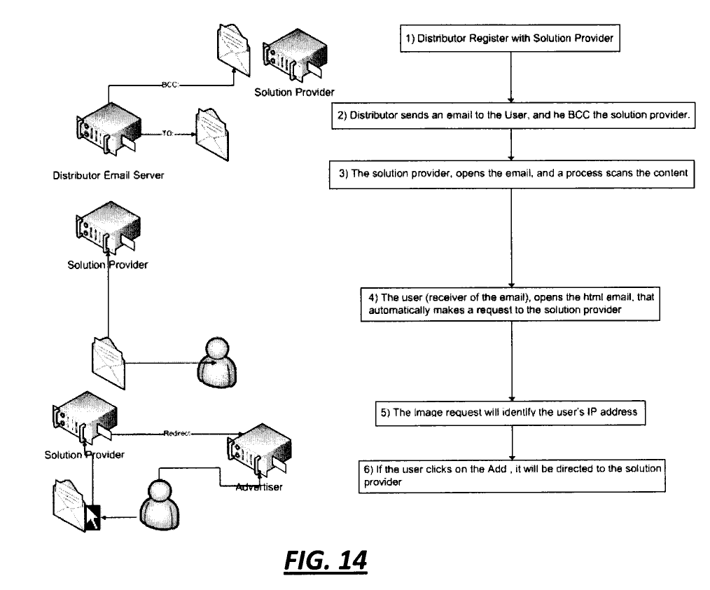

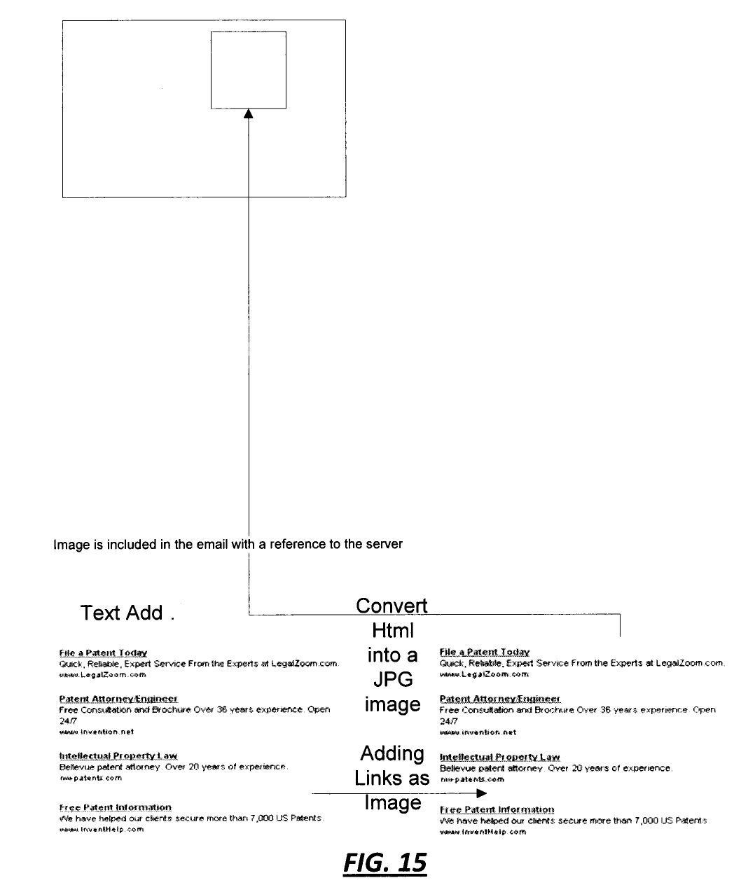

Alert system 100 may be configured in any number of suitable ways to provide customized alerts to a user. In one example embodiment, alert system 100 comprises a variety of servers providing various functionalities. The servers may be physical or virtual servers. Alternatively, each server can be implemented as a distinct program module executing on one or more computer systems. In one illustrative example, alert system 100 comprises web server 130, email server 132, SMS server 134, voice message server 136, file server 140, and back-end server 150, and content server 160, as depicted in FIG. 1. Web server 130, email server 132, SMS server 134, voice message server 136, and content server 160 are communicatively linked to one or more communication networks, such as the Internet 170, and telecommunications network 172. User terminal 180 is communicatively linked to one or more networks 170 and 172, over which the alerts generated and transmitted by alert system 100 can be received and viewed by a user. User terminal 180 can be at least one device adapted to interface with network 170, such as, for example, a desktop computer, a laptop, a mobile handheld device, or a cellular telephone. The particular association of atoms 110 into molecules 120 can occur based upon any number of criteria. For instance, in one embodiment, the association of atoms 110 may be based upon pre-selected criteria, as depicted in FIG. 8 and described by example below with reference to Table 2. In another embodiment, the association of atoms 110 may be based upon logical associations, as depicted in FIG. 9 and described by example below with reference to Table 3. In yet another embodiment, the association of atoms 110 may be based upon user history and/or the current use habits of a particular user, as depicted in FIG. 10 and described by example below with reference to Table 4.

Notably, aspects of the invention seek to construct or expand alert content molecules intelligently, i.e., with the use of algorithmic criteria, so that the constructed or expanded molecules will have content desired or welcomed by the user. For example, one type of algorithmic criteria is specifically adapted to assess a measure of relevance between atoms or between an atom and a molecule of atoms. In one such embodiment, the measure of relevance, or relevancy score, is based on an ordered arrangement of atoms. For instance, an alert for weather at a particular location may have relevance to an alert for airfare to that location; however, the relevancy score for adding a new airfare alert to an existing molecule having a weather alert for the location would be lower than the relevancy score for adding a new weather alert to an existing molecule having the airfare alert to that location. This difference between the orderings of atoms can be explained by the relative strengths of inferences that may be drawn about the user's interests or planned activities. In the above example, the fact that a user is interested in weather at a particular city does not strongly suggest that the user is interested in traveling to that city; on the other hand, the fact that a user is receiving airfare information to the city strongly suggests that the user would be interested in weather there.

In a related embodiment, recent historic transactions by the user are utilized to construct or expand molecules of alerts. For instance, knowledge by the alert system of the fact that a user has recently booked a rental car at a particular location is used to amplify the measure of relevance for all auto travel-related alert atoms, such as gas prices and traffic alerts. In another related embodiment, geographic indicia are used to adjust the relevancy score. For example, the presence of an alert for airfare to a certain airport in an existing molecule of alerts, along with an existence of a weather alert at a specified postal code that is in the general region of the airport, can be used to increase the relevancy scores for gas price alert atoms for locations along major roads between the specified postal code, and the postal code of the airport.

In certain embodiments incorporating transaction information, system 100 includes an interface with an electronic commerce system (not shown). The electronic commerce interface can be a portal linking to merchants, or a user interface shell through which the transactions with merchants can be carried out. In one such embodiment, system 100 obtains transaction information from the merchants, or via monitoring of the transaction through user interface shell. The information contained in electronic transmissions, or alerts, that are delivered to user terminal 180 is based upon the association of atoms 110 to form molecules 120. The association of atoms 110 may occur, for example, based upon pre-selected associations, logical associations, user history, or current use. Referring to FIG. 8, a pre-selected association generally begins with a user login. If the user is new, the user may create a user profile containing information relating to the user. The user may then select one or more atoms corresponding to information the user wishes to receive. Next, the alert system 100 may prompt the user by offering the option of adding additional atoms 110 which are automatically identified as being related to the selected atom 110. The following table illustrates examples of pre-selected associations:

TABLE 2

| User-Selected Atom | Pre-Selected Associations |
|---|---|
| Airfare | Hotel Availability; Car Rental Prices; Gasoline |
| | Prices |
| Sports Scores | Sporting Events |
| Car Rental Prices | Gasoline Prices; Hotel Availability; Sporting Events |

If a user selects airfare as the desired information to be delivered by an alert, for example, alert system 100 will present the user with the option of also adding atoms 110 corresponding to hotel availability, car rental prices, and gasoline prices. A molecule 120 can thereby be constructed that provides information corresponding to the initially selected atom 110 (in this case, for airfare) as well as any of the pre-selected atoms 110 (such as hotel availability, car rental prices, or gasoline prices) subsequently chosen by the user.

Referring to FIG. 9, a logical association generally begins with a login by user. If the user is new, the user may create a user profile containing information relating to the user. The user may then select one or more atoms 110 corresponding to information the user wishes to receive. Next, alert system 100 may prompt the user to select additional atoms 110 based upon logical associations between selected atoms 110 and non-selected atoms 110. The following table illustrates examples of pre-selected associations:

TABLE 3

| | Second | | |
|---|---|---|---|
| | User- | | |
| First User- | Selected | Inferred | |
| Selected Atom | Atom | Activity | Logical Associations |
| Airfare | Scuba | Beach Travel | Vacation packages; Rental |
| | Diving | | gear; Dive shops; Scuba |
| | | | lessons |
| | Winter | Holiday | Cold-weather clothing; |
| | Break | Travel | shopping deals; Weather |
| | | | updates; |
| Sports Scores | Las | Gambling | Online gambling |
| | Vegas | | opportunities; Airfare to Las |
| | Hotels | | Vegas; Sporting Events in Las |
| | | | Vegas |
| | Baseball | Sports Fan | Memorabilia purchases; |
| | Tickets | | Sportswear; Fantasy baseball |
| | | | participation; Stadium parking |

If a user selects airfare and scuba diving as initial subject matters, for example, alert system 100 may infer that the user intends to plan a beach vacation. As such, alert system 100 may suggest the association of additional atoms 110 related to beach travel, such a beach vacation packages, options for scuba gear rental, dive shops, and scuba lessons. If the user selects a date range of the airfare during the time period associated with Winter Break rather than scuba diving, then alert system 100 may infer that the user intends to travel during the Holiday Season. As such, alert system 100 may suggest the association of additional atoms 110 related to cold-weather, shopping deals, weather updates, and other Holiday-related interests.

Referring to FIG. 10, an association based upon user history or current use also generally begins with a login by user. If the user is new, the user may create a user profile containing information relating to the user. The user may then select one or more atoms 110 corresponding to information the user wishes to receive. Next, alert system 100 may prompt the user to select additional atoms 110 based upon the user's current use habits or the past preferences of the user. The following table illustrates examples of associations based upon current use or historical usage:

TABLE 4

| User Profile | Activity | Usage-Based Action |
|---|---|---|
| A | Viewed ads for beach vacations | Add atom for |
| | | vacation packages |
| | Purchased books online | Add atom for |
| | | purchasing music |
| | | online |
| | Search online for new jobs | Add atom for real estate |
| | Infrequent viewing of sports | Remove atom for |
| | scores | sports scores |
| | Removed airfare from alerts | Remove atom for |
| | | hotel availability |

If a user has recently viewed advertisement for beach vacations, for example, alert system 100 may suggest the association of an atom 110 to the user's molecule 120 providing information relating to all-inclusive vacation packages at various beach destinations. Similarly, if a user purchases books based on an alert that was receiver, alert system 100 may suggest that association of an atom 110 to the user's molecule 120 for purchasing music online. Alternatively, if alert system 100 recognizes that a user rarely or never views sports scores, then alert system 100 may recommend removing the atom 110 corresponding to sports scores.

Referring to FIG. 8-10, alert system 100 generally updates the user profile if an additional atom 110 has been added to or removed from a molecule 120. Based upon the addition of the new atom 110 to the molecule 120, web server 130 can patrol the desired network to cull information relating to the updated molecule 120. When information relating to the subject matter corresponding to the atoms 110 of a user's molecule 120 is identified, alert system 100 can subsequently generate an alert containing the requested information and deliver the alert to user terminal 180.

One skilled in the art will recognize that any number of associations between atoms 110 can be achieved. In fact, the compounding nature of associations means that molecules 120 of a nearly unlimited number of atoms 110 can be achieved. Since each subject matter may be related to several other subject matters, which in turn may also be related to several other subject matters, the size and complexity of possible molecules 120 is almost without limit. At a certain point, however, the increasing size of molecules 120 may actually reduce their effectiveness. Specifically, while molecules 120 of a relatively discrete size may provide desired pieces of information to a user, overly large molecules 120 can actually inundate a user with information such that the user ignores the alert or discontinues use of the alert altogether.

Therefore, one aspect of the invention is directed to the ability to limit the size and complexity of molecules 120 by identifying boundaries for the construction of molecules 120. In an embodiment, alert system 100 may contain a limit on the number of atoms 110 that can be automatically associated. For example, alert system 100 may prevent pre-selected associations from exceeding four atoms. Referring to FIG. 7, this could mean that even though atoms 110 of molecule 120a or molecule 120c may be related to atoms 110 of molecule 120c, pre-selected associations of atoms 110 to molecule 120c would not be permitted unless specifically authorized or requested by the user. One skilled in the art will readily recognize, however, that the size limits of molecules could be pre-determined to permit any number of associations between atoms 110 of various lengths.

In another embodiment, alert system 100 may automatically disassociate, or recommend dissociation of, atoms 110 which are recognized as not have been frequently or recently used. For example, alert system 100 may be able to monitor the extent to which a user makes use of information corresponding to a particular subject matter. In particular, alert system 100 could monitor whether a user elects to access subject matter-related indicia. Referring to Table 1, alert system 100 may provide advertisements or coupons related to the various subject matters. If a user occasionally clinks on the links corresponding to car rental availability, gasoline prices, and airfare, but rarely or never clicks on the links corresponding to hotel availability, alert system 100 may suggest that the atom 110 corresponding to hotel availability be dissociated from molecule 120.

In a further embodiment, alert system 100 may recognize particular associations of atoms 110 as an inferred activity. Such inferred activities could be, for example, regional interests, sports, or travel. Referring to Table 1, it may be inferred that the association of atoms 110 corresponding to hotel availability, car rental prices, airfare, and gasoline prices could be relates to a travel activity. Similarly, it may be inferred that the association of atoms 110 corresponding to sports scores and sporting event ticket relates to a sports activity. By classifying a certain molecule within a particular inferred activity, alert system 100 can thereby limit the universe of possible subject matters to those that correspond to the particular inferred activity. For example, other subject matters that might be classified within a sports activity group include gambling odds, parking venues, game-time weather updates, and sports bars. Similarly, other subject matters that might be classified within a travel activity group include restaurants, tourist attractions, and traffic updates, and regional entertainment. It will further be recognized that such subject matters could be classified within several inferred activities.

The ability to classify within various inferred activities atoms corresponding to different subject matters is particularly useful in embodiments in which alert system 100 can suggest additional atoms 110 based upon logical associations. In particular, since any number of atoms can be successively related, the selection of atoms 110 from within an inferred activity provides logical criteria for limiting the size of molecules 120 or pool of atoms 110 suggested to a user.

In yet another embodiment, alert system 100 may automatically query a user after a pre-determined period of time to determine whether information corresponding to a particular subject matter should continue to be delivered. For example, alert system 100 may be adapted to keep track of how much time as elapsed since a particular molecule 120 was formed or since a particular atom 110 was added to a molecule 120. If the predetermined period is, for example, six months, then alert system 100 can verify after six months whether the user wishes to continue receiving alerts related to a particular subject matter. Referring to Table 1, car rental availability, gasoline prices, airfare, and hotel availability may, for example, have been added to a molecule 120 at one-month increments. Accordingly, alert system 100 may query the user at one-month intervals whether the atoms 110 respectively corresponding to these subject matters should be dissociated from the molecule 120.

In another type of embodiment, adjustment of the relevancy scoring for specific molecules and atoms enables the amount of “catalyst,” that is, the degree to which molecule expansion is suggested to a user, to be varied. Thus, a relevancy score threshold can be established that must be met or exceeded before the addition of a particular atom is suggested to a user. The catalyst can be throttled by users (i.e., recipients of alerts) in one such embodiment. In anther embodiment, the catalyst can be throttled by advertisers. In one such embodiment, advertisers associated with existing alerts may choose to pay premium rates for “low catalyst” molecules, which would result in having more concentrated advertising presented to the user. Alternatively, those advertisers may opt to pay lower rates with the understanding that the molecules in which they are participating are “high-catalyst” molecules, which are likely to grow to a larger size (i.e., have more alerts and more advertisements). A similar approach may be used for pricing advertising space to advertisers associated with alert atoms that are being added to existing molecules, where premium rates may be charged to be added to low-catalyst molecules. In practicing these types of embodiments, it would be possible for users receiving multiple molecules of alerts to have different molecules assigned different catalyst levels.

The embodiments above are intended to be illustrative and not limiting. Additional embodiments are within the claims. In addition, although aspects of the present invention have been described with reference to particular embodiments, those skilled in the art will recognize that changes can be made in form and detail without departing from the spirit and scope of the invention. Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

### RSS

Creating an Alert using RSS is a process whereby a developer needs to clearly identify and understand the source or sources of information which will serve as the foundation for the alert content. In one embodiment, one (or series of) XML file(s) define the specific parameters for the alert. From that set of information the developer configures the alert criteria that a user must select to extract from the feeds the alertable content.

Let's take an example of developing an alert off the publicly available CNN RSS news feed to give users the options to receive either World News, US News or both.

To create an RSS based alert, developers have to identify two core fields criterion (<Fields>): the source of information (<Field>) and how the alert is to be presented to users (<DC>).

The first step is to identify the appropriate feeds to construct the Alert. In this example we will go to the CNN RSS Services catalog at http://www.cnn.com/services/rss/?iref=rsssvcs and identify the two feeds in which we are interested for the World News (http://rss.cnn.com/rss/cnn_world.rss) and US News RSS (http://rss.cnn.com/rss/cnn_us.rss) alert services.

These two feeds will be used as source identified for the <Field> and selector for the creation of the alert:

```
<Field ID=“RssNode_1” Title=“CNN news” Type=“string”
MultiSelect=“True”
WebControl=“CheckBoxList” Width=“300px” DefaultValidValueID=“”>
    <ValidValue ID=“1” Value=“http://rss.cnn.com/rss/cnn_us.rss”
    Text=“US” Selected=“” />
    <ValidValue ID=“2” Value=“http://rss.cnn.com/rss/cnn_world.rss”
    Text=“World” Selected=“” />
</Field>
```

These second step is to identify how the alert is to be configured by the user. Alerts.com offers a series of components a Developer can use based on the specificity or requirements of the alert being developed. In this instance we will use a weekly date picker as the schedule type (for a listing of all the available components please reference the DC Library):

```
<DC ID=“1” Enabled=“true” ScheduleType=“SCHD”>
    <Field ID=“DC1_WeekDayPicker” Title=“Select Schedule”
    Regex=“RegularExpression” MultiSelect=“True”
    WebControl=“ScheduleWeekDayTimePicker” Width=“236px”
    DefaultValidValue=“0000000||9:00 AM” />
</DC>
```

We now just need to join these fields, give our Alert a group ID (which will be supplied by Alerts.com) and name the alert:

```
<AlertInterface ID=“35” Name=“My First Alert”>
  <Fields>
    <Field ID=“RssNode_1” Title=“CNN news” Type=“string”
    MultiSelect=“True”
    WebControl=“CheckBoxList” Width=“300px”
    DefaultValidValueID=“”>
      <ValidValue ID=“1” Value=“http://rss.cnn.com/rss/cnn_us.rss”
      Text=“US” Selected=“” />
      <ValidValue ID=“2”
      Value=“http://rss.cnn.com/rss/cnn_world.rss”
      Text=“World” Selected=“” />
    </Field>
    <DC ID=“1” Enabled=“true” ScheduleType=“SCHD”>
      <Field ID=“DC1_WeekDayPicker” Title=“Select Schedule”
      Regex=“RegularExpression” MultiSelect=“True”
      WebControl=“ScheduleWeekDayTimePicker” Width=“236px”
      DefaultValidValue=“0000000||9:00 AM” />
    </DC>
  </Fields>
</AlertInterface>
```

All it takes to create an alert in this embodiment is basically writing the XML as portrayed in table 3. This XML will create an UI interface that is represented in Table 4 allowing users to subscribe to that alert.

How does it Work?

Alerts.com created the concept of the AML (alerts markup language) as a dynamic interface to create, develop and publish alerts very efficiently. In the case of RSS Infrastructure, Alerts.com just needs the Developer to identify one or more feeds and corresponding values where the ID starts with RSS. In the example provided we have 2 checkboxes under RSSNode_1. When our RSS Alert reads RSSNode_1 it understands that whatever is inside is an RSS Feed.

Let's review the AML line by line of

```
<AlertInterface ID=“35” Name=“My First Alert”>
<Field ID=“RssNode_1” Title=“CNN news” Type=“string”
MultiSelect=“True”
WebControl=“CheckBoxList” Width=“300px” DefaultValidValueID=“”>
    <ValidValue ID=“1” Value=“http://rss.cnn.com/rss/cnn_us.rss”
    Text=“US” Selected=“” />
    <ValidValue ID=“2” Value=“http://rss.cnn.com/rss/cnn_world.rss”
    Text=“World” Selected=“” />
</Field>
```

AlertInterface ID[int] is a unique identifier which will be provided by Alerts.com when the developers submits the alert to Alerts.com.
Name is the name the alert will be identified as. Note that we do not allow for duplicate names and they need to be user centric.
ID[int] is the unique identifier of a field in the interface. If the first 3 letters of this field are Rss (Case sensitive) then our RSS alert will identify it as an RSS Feed.
Type [Control type], this is the type of the result; in this case because an RSS is a URL it will be a string. If the output was an integer then the type would be int. AML supports all the Types available with the Microsoft .net Framework.
Title[String]: This is the title of the control, as we can see in the table 1, it will appear at the left side of the control (CNN news)
Multiselect [True|False]: Indicates if the control supports multiple selections or just a single value. This property depends on the control type, in our example, as a user can select more than one option, the selection is a checkbox (versus a radio button) and MultiSelect is set to True
WebControl [Control Type]: The control type is the control that will be rendered.
   DropDownList
   TextBox
   CheckBoxList
      AML supports all available type of input controls of HTML, and it also supports the possibility to create specific custom controls.
      Dynamic RSS Feeds vs. Static RSS Feeds

The alert experience can be enriched in a related embodiment by considering Dynamic versus RSS which applies in some specific scenarios. Usually information that is dynamically generated is suited for richer alerts, such as constantly updated list of crimes in a specific zip code, or the step-by-step tracking of a specific package ID, or even a tornado warning for a county. In these use cases Developers will need to provide a way to ask the user for that information. The key difference between a static RSS feed and a dynamic RSS feed, is that the dynamic RSS feed allows for one or more additional filtering parameters such as, for example, a zip code in the case of a location specific alert, a keyword in the case of a feed specific alert (low fat diet when the single RSS feed offers multiple diet recipes). http://www.rssexamples.com/example.rss is a static RSS feed (no parameters) http://www.rssexamples.cod/dynimic.php?zipcode=98034 is a dynamic RSS feed with one parameter, in this case “zip code” with a value of “98034”.

Example of how to Create an Alert with Dynamic Feeds

In creating an RSS Alert with dynamic feeds, the dynamic parameter(s) as another AML field component such as <Field ID=“zipcode” . . . is specified, as illustrated in the example below.

```
<AlertInterface ID=“39” Name=“LocalNews”>
<Fields>
    <Field ID=“RssNode” Title=“” Type=“string” Text=“pepito”
    Regex=“”
    MultiSelect=“False” WebControl=“HiddenField” Width=“236px”
    DefaultValidValue=“http://www.google.com/news?geo=
    [zipcode]&amp;nolr=1&amp;
    output=rss” Required=“True” />
    <Field ID=“zipcode” Title=“Zip Code” Type=“int”
    Regex=“\d{5}” MultiSelect=“False”
    WebControl=“TextBox” Width=“236px”
    DefaultValidValue=“98004” />
<DC ID=“1” Enabled=“true” ScheduleType=“SCHD”>
    <Field ID=“DC1_WeekDayPicker” Title=“Select Schedule”
    Regex=“RegularExpression”
    MultiSelect=“True” WebControl=“ScheduleWeekDayTimePicker”
    Width=“236px”
    DefaultValidValue=“0000000||9:00 AM” />
</DC>
</Fields>
</AlertInterface>
```

In table 5 above, the example is leveraging the Google local news RSS feed. The local news RSS is http://www.google.com/news?geo=[zipcode]&amp;nolr=1&amp;output=rss where [zip code] is the zip code of the location.

To create this dynamic RSS alert subscription in the present example, the only thing needed is to add the dynamic parameter with parenthesis, in this instance case [zip code], which automatically creates one more AML field using zip code as ID.

Basically what the RSS Alert will do is insert the dynamic parameter to create the actual field. For example, a user requesting local Google news for zip code 98034 would specify the zip code in the input box and once the user subscribes to that alert, the system will fetch http://www.google.com/news?geo=[zipcode]&amp;nolr=1&amp;output=rss and will replace [zip code] with 98034 before making the request to create a subscription like: http://www.google.com/news?geo=98034&amp;nolr=1&amp;output=rss

### Search

The RSS Infrastructure offers an additional exiting feature in one embodiment by enabling the capability to create search functionalities within the RSS feed and return only the results of the search query. For example, consider the use case above for local news alert but a user only wants to have results returned based on specific criteria. To extract just the content which includes the filtering parameters a developer would use the Search RSS Infrastructure functionality.

Similar to the example above for the addition of a Dynamic field, the Search field is another field within the <Fields> of the AML.

```
<AlertInterface ID=“39” Name=“LocalNews”>
<Fields>
    <Field ID=“RssNode” Title=“” Type=“string” Text=“pepito” Regex=“”
MultiSelect=“False” WebControl=“HiddenField” Width=“236px”
DefaultValidValue=“http://www.google.com/news?geo=[zipcode]&amp;nolr=1&amp;output
=rss” Required=“True” />
    <Field ID=“SearchCriteria” Title=“Search Criteria” Type=“string” Regex=“”
MultiSelect=“False” WebControl=“TextBox” Width=“236px” DefaultValidValue=“” /><Field
ID=“SearchType” Title=“Search Type” Type=“int” MultiSelect=“False”
WebControl=“DropDownList” Width=“300px” DefaultValidValueID=“2”><ValidValue ID=“1”
Value=“1” Text=“All of the words” Selected=“” /><ValidValue ID=“2” Value=“2” Text=“Any of
the words” Selected=“true” /><ValidValue ID=“3” Value=“3” Text=“The Exact Phrase”
Selected=“” />
</Field>
    <Field ID=“zipcode” Title=“Zip Code” Type=“int” Regex=“\d{5}” MultiSelect=“False”
WebControl=“TextBox” Width=“236px” DefaultValidValue=“98004” />
<DC ID=“1” Enabled=“true” ScheduleType=“SCHD”>
<Field ID=“DC1_WeekDayPicker” Title=“Select Schedule” Regex=“RegularExpression”
MultiSelect=“True” WebControl=“ScheduleWeekDayTimePicker” Width=“236px”
DefaultValidValue=“0000000||9:00 AM” />
</DC>
</Fields>
</AlertInterface>
```

Hence, in this example, all that is required to include the search functionality is to add the search criteria field. A further enhancement of the Search functionality is to provide a “type” such as Any of the Words, All of the Words, Exact Phrase otherwise, by default the RSS alert, will search in the feed for all of the words.

### Email

To enable email as an effective advertising medium, preferably, a solution compatible with current industry standards so as not to create a disruption to established ad networks processes is desired. Accordingly, aspects of the invention are directed to:

1—Alleviating the problem of caching to monetize email with advertisements

2—Maximizing email advertisements monetization by enabling contextual and geo location ad serving

3—Monetizing text advertisements on CPM just like display advertisements, not just CPC

Solution to the Caching Problem

Considering that only HTML emails will allow for the display of images, one approach is directed to HTML emails.

To eliminate the caching problem, the architecture of the ad delivery in one embodiment has a double link infrastructure in which a hyperlink is embedded in the email and links to a routing server which, in turn, is used to redirect the link to an ad referral service hosted on an ad server. The referral service is dynamically linked to a network advertising campaign program that manages the ad campaign. The advertising campaign program can be similar to the way it is currently being done on the web.

Upon requesting the download of an image the embedded hyperlink makes a call to the routing server which invoke a redirect request to serve the image from the ad server. As the ad server is emulating serving ads in web pages, the standard ad network infrastructure can be used to serve the proper advertisements.

The solution of this embodiment alleviates the need for caching of advertising and will ensure that the images are being served when an email is opened and images that are downloaded are appropriately a part of the capped campaign.

As in the case of user requested content, the identification of the origination of the embedded hyperlink can be identified, such that the advertiser can be guaranteed that the ad served is contextual with the requested content type.

Maximizing Email Advertisement Monetization

Considering that HTML emails will allow for the display of images, one approach is directed to HTML emails.

To maximize advertisement monetization into an email and serve targeted emails as a function of the context and content of an email, an ad network according to embodiments of the invention obtains an understanding of the content of that email at the time the ad is to be served.

To ensure that the ad network has the ability to understand when an ad is to be served, the email client makes a call to an ad server to indicate that an ad is to be served. Additionally, the Ad Server (ADS) has the ability to identify the content of the email to provide the right contextual advertisement.

In order to identify the content of the email, the system ensures that each email is not only sent to the receiver but also to the solution provider server (AKA the solution server), which stores a copy of the email, or a record otherwise representing the content of the email, clearly identified as associated with this specific email. One approach is to utilize any of the recipient email fields in the email header, such as, for example, the Blind Carbon Copy (BCC) recipient email field in the email header. Using the To or the Carbon Copy (cc) fields would indicate to the recipient that their personal and/or private user-requested content has been shared, which may not be a preferred solution in certain situations. The body of the email contains a unique image identifier (UII) that later will be used to help serve the right targeted advertisement, regardless of whether the email is being opened by the original recipient or anyone who may have received a copy of the email being forwarded by the original recipient.

The embodiment described above exemplifies one approach to implementing an aspect of the invention in which a record is created, for the use of the solution provider, representing information related to the delivery of the targeted email in which to later serve ads. The scope and spirit of the invention should be understood to include alternative ways in which the record is created, and how the information critical to the record is delivered to the solution provider.

For instance, in an alternative approach to using the email header fields, the system can generate a separate email, RSS feed, instant message, or other type of message, addressed to the solution provider. The separate email can, in one embodiment, be simply a copy of the targeted email. In another embodiment, the separate email can contain relevant information based on the targeted email (such as the UII, and optionally, various keywords or other content summary) while omitting other content of the targeted email. In a related embodiment in which the provider of the user-requested content supplies a distilled or summarized version of the content of the targeted email to the solution provider, the distillation or summary is prepared by a third party.

In the use of specially-prepared messages informing the solution providers of the sending of the targeted emails, where the specially-prepared messages are distinct from the targeted emails themselves, the provider of user-requested content can control the extent to which information about the content is shared with solution providers. Controlling the extent of information sharing may be particularly useful in situations where protection of the identity, or protection of certain personalized content requested by the recipient of the targeted email is needed. Additionally, the user-requested content provider may wish to institute a multi-level pricing structure in which advertisers are charged varying amounts for varying levels of detail of the email content.

In one related embodiment, the provider of the user-requested content includes information about the structure of the user-requested emails in the specially-prepared messages to the solution providers. In one simple example of the use of such structural information, the advertiser may stack related advertisements to be viewed in a particular email for the user. For instance, assuming that a single user-requested email contains a series of three alerts, an advertisement associated with a first one of those alerts may include some “hook” to stimulate the user's interest in the advertisements. The next ad associated with the next alert in the email can be related in some way to the first ad, and may now offer the product or service being advertised. A further ad associated with the third alert in the email may offer a discount on that product or service.

In another related embodiment, the provider of the user-requested content utilizes user profile information to build the specially-prepared messages associated with corresponding user-requested emails. For example, profile information can include demographic-type data on the user, knowledge of the user obtained based on other content requested by that user (to be delivered in separate emails), knowledge of the user based on the contextual content being delivered in the user-requested email, and combinations thereof. Specially-prepared messages to solution providers having user profile information are highly valuable to direct advertisers, who can build user-specific or demographic-specific advertisement campaigns that are relevant to the content of each user-requested targeted email, and that are coordinated with other user-requested targeted emails. In one example, consider a user that receives gas price alerts for a particular postal code in a first email and traffic alerts for a particular driving route in a separate email. Knowing not only the postal code for the gas alerts, but also the driving route, an advertiser can target an advertisement promoting oil change service stations in the first email that indicates locations of oil change service stations in both, the postal code, and at locations along the driving route.

In one aspect of the invention, an advertiser can create dynamic offers based on the targeted user's response or non-response to previous ads, together with the advertiser's knowledge of future user-requested emails to be delivered to that user. For example, in the case of a user that is known to receive three separate emails at different times of the day, a marketing campaign can: (a) in association with the first of these emails, offer a product for sale; (b) if the user is served that advertisement but does not respond to it, then in the second email, offer the same product at a 15% discount; and (c) if the user does not respond to either advertisement in the first or the second email, offer the product at a deeper discount of 30%. Clearly, the subsequent advertised offers served to the user can and should be different if the user responds to an earlier advertisement.

In another aspect of the invention, the UUI associated with the user-requested email is used by the solution provider to associate events occurring subsequent to the serving of the advertisement with the particular user-requested content email. An example of a subsequent event is the response by the user to the advertisement (i.e. the user's clicking on the ad). Another subsequent event is the user transacting with a merchant in response to the user's responding to the advertisement served in the targeted email. These types of associations between the targeted email and the subsequent events can be used as a basis for pay-per click or pay-per-sale revenue for the solution provider or the provider of the user-requested content.

When the recipient opens the HTML email, the email client program makes a request to the solution provider server to deliver images in the email, inclusive of the advertisements to be served. The request includes the specific UII to identify that email uniquely. In response to the request, the solution provider retrieves a copy of the original email, or retrieves the record representing the content of that original email, either of which is easily identified by the same unique UII. Upon retrieving the email content, the provider can then check the content of the email to determine which advertisement would be most appropriately targeted to the recipient in light of not only the content type, but also the specific content and subject matter of the email. Additionally, the email client can also make a request to extract the IP address used by the solution provider to then identify the location of the user and not only contextually serve an ad, but also geographically target the advertisement. With knowledge of the content of the email and the location, the ADS decides what is the best ad to serve.

If the recipient of the email clicks on a link in the email, a web browser is directed to the solution provider, and supplies the UII to the solution provider. The solution provider, based on the UII, determines which advertisement was served to that email and makes the appropriate redirect to the web page associated with that advertiser.

In one example embodiment, the Distributor is charged to insert into every emails that it sends the UII. The UII image used as the triggering mechanism needs to be properly tagged to identify the specific of the email and its origination or the [IDENTIFIER].

href=“http://www.solutionprovider.com/click[IDENTIFIER]”><img

src=http://www.solutionprovider.com/Get[IDENTIFIER].JPG>

For example the IDENTIFIER might be 3499587y7gi and the link will look like:

<a href=“http://www.solutionprovider.com/click3499587y7gi”><im g src=“http://www.solutionprovider.com/Get3499587y7gi.JPG” style=“width: 98px; height: 265px”/></a>

When creating and sending the email the server will use the [IDENTIFIER] to dynamically create an email address using the IDENTIFIER as the name of the email to create the [IDENTIFIER_EMAIL]—for example 3499587y7gi@solutionprovider.com

Upon sending the email to recipient the Distributor inserts the UII and places the [IDENTIFIER_EMAIL], such as, for example, as a Blind Carbon Copy (BCC) recipient to the email being sent.

Once the Distributor sends the email then the email is double tagged with both [IDENTIFIER] and [IDENTIFIER_EMAIL].

When a user opens the HTML email and requests to download the images:
the UII enables the email to be identified through the [IDENTIFIER]. With this identifier, the solution provider can get the email content because the email (or a separate message based on that email) was sent to the solution provider previously, thus allowing the ADS to know at least some (or, optionally, all) of the content of the email.
When the request takes place, the solution provider server gets a request from an IP address. This IP address is used to identify the location of the user.
Coupling the two elements provides all the information necessary to serve the best ad at runtime to the user.

### Serving Text Links in Email Images

The challenge experienced with display advertisements in emails as a function of whether or not an image is downloaded leads some advertisers to send text advertisements which will always render in both HTML and Text Based emails. Yet, the problem of caching persists in that even with text ads when a user open an email 3 month later the ad can have expired and can't be served.

One embodiment of the invention dynamically converts a text ad to be an image of the text ad, and serves it as SERVER images. Accordingly, the advertisement is served only when the user opens the email. With this technology, the industry will be able to serve text ads into emails without the problem of expiration.

1. The Image is added into the email with a link to the server.

2. When the user reads the email, the email client makes a request to the Server requesting the image.

3. The server makes a request to the Ad Server to request for the html FEED for text links.

4. The html text links are converted on the fly to a jpg or other suitable image.

5. The links are added to the jpg image based on the MAPS.

6. The image is served to the email client with the ADDS

The embodiments above are intended to be illustrative and not limiting. Although aspects of the present invention have been described with reference to particular embodiments, those skilled in the art will recognize that changes can be made in form and detail without departing from the spirit and scope of the invention. Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

1. A system for gathering and delivering user-requested content substantially as shown and described herein, and its equivalents

2. A system for providing alerts as substantially shown and described herein.

3. A system for gathering and delivering user-requested content utilizing at least one real simple syndication (RSS) feed service as a content source substantially as shown and described herein.
